(19) United States
(12) Patent Application Publication
(10) Pub. No.: US 2026/0332227 A1
(43) Pub. Date: Oct. 22, 2026

(54) SPINAL CODE MULTIPLE INPUT MULTIPLE OUTPUT AWARE REPETITIONS

(71) Applicant: QUALCOMM Incorporated, San Diego, CA (US)

(72) Inventors: Peer BERGER, Hod Hasharon (IL); Matan GUETTA, San Diego, CA (US); Amit BAR-OR TILLINGER, Tel-Aviv (IL)

(21) Appl. No.: 19/182,404

(22) Filed: Apr. 17, 2025

(51) Int. Cl. H04B 7/06; H04B 7/0413

(52) U.S. Cl. CPC H04B 7/0663; H04B 7/0413

(57) ABSTRACT

Various aspects of the present disclosure generally relate to wireless communication. In some aspects, a transmitting device may obtain a plurality of spinal symbols associated with a multiple input multiple output (MIMO) spinal code encoding scheme. The transmitting device may map each spinal symbol to one or more transmission vectors of a MIMO transmission matrix based at least in part on a layer index within a resource element of a plurality of resource elements. At least one spinal symbol is mapped to at least two different layers and at least to two different resource elements. The transmitting device may transmit the plurality of spinal symbols in accordance with the MIMO transmission matrix. Numerous other aspects are described.

### FIELD OF THE DISCLOSURE

Aspects of the present disclosure generally relate to wireless communication and specifically relate to techniques, apparatuses, and methods associated with spinal code multiple input multiple output aware repetitions.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Spinal codes are a class of Euclidean codes, which are typically rate-less codes that can handle time-varying channel conditions without requiring explicit bit rate selection. Spinal codes involve transmission at a higher rate than a channel can sustain followed by iterative re-transmission of information bits to lower the effective rate until a decoding success occurs (for example, until the receiver transmits an acknowledgment or a negative acknowledgment). More specifically, a transmitting device may perform the encoding once, and the channel rate may be changed based at least in part on the total quantity of channel uses.

### SUMMARY

Some aspects described herein relate to a method of wireless communication performed by a transmitting device. The method may include obtaining a plurality of spinal symbols associated with a multiple input multiple output (MIMO) spinal code encoding scheme. The method may include mapping each spinal symbol of the plurality of spinal symbols to one or more transmission vectors of a plurality of transmission vectors of a MIMO transmission matrix based at least in part on a layer index within a resource element of a plurality of resource elements, and where at least one spinal symbol of the plurality of spinal symbols is mapped to at least a first layer and a second layer of the plurality of layers and at least to a first resource element and a second resource element of a plurality of resource elements of the MIMO spinal code encoding scheme in accordance with a repetition pattern. The method may include transmitting the plurality of spinal symbols in accordance with the MIMO transmission matrix.

Some aspects described herein relate to a method of wireless communication performed by a receiving device. The method may include receiving a plurality of spinal symbols associated with a MIMO spinal code encoding scheme, where each spinal symbol of the plurality of spinal symbols is mapped to one or more transmission vectors of a plurality of transmission vectors of a MIMO transmission matrix based at least in part on a layer index within a resource element of a plurality of resource elements, and where at least one spinal symbol of the plurality of spinal symbols is mapped to different layers of a plurality of layers of the MIMO spinal code encoding scheme and different resource elements of the plurality of resource elements in accordance with a repetition pattern. The method may include decoding the plurality of spinal symbols.

Some aspects described herein relate to a non-transitory computer-readable medium that stores a set of instructions for wireless communication by a transmitting device. The set of instructions, when executed by one or more processors of the transmitting device, may cause the transmitting device to obtain a plurality of spinal symbols associated with a MIMO spinal code encoding scheme. The set of instructions, when executed by one or more processors of the transmitting device, may cause the transmitting device to map each spinal symbol of the plurality of spinal symbols to one or more transmission vectors of a plurality of transmission vectors of a MIMO transmission matrix based at least in part on a layer index within a resource element of a plurality of resource elements, and where at least one spinal symbol of the plurality of spinal symbols is mapped to at least a first layer and a second layer of the plurality of layers and at least to a first resource element and a second resource element of a plurality of resource elements of the MIMO spinal code encoding scheme in accordance with a repetition pattern. The set of instructions, when executed by one or more processors of the transmitting device, may cause the transmitting device to transmit the plurality of spinal symbols in accordance with the MIMO transmission matrix.

Some aspects described herein relate to a non-transitory computer-readable medium that stores a set of instructions for wireless communication by a receiving device. The set of instructions, when executed by one or more processors of the receiving device, may cause the receiving device to receive a plurality of spinal symbols associated with a MIMO spinal code encoding scheme, where each spinal symbol of the plurality of spinal symbols is mapped to one or more transmission vectors of a plurality of transmission vectors of a MIMO transmission matrix based at least in part on a layer index within a resource element of a plurality of resource elements, and where at least one spinal symbol of the plurality of spinal symbols is mapped to different layers of a plurality of layers of the MIMO spinal code encoding scheme and different resource elements of the plurality of resource elements in accordance with a repetition pattern. The set of instructions, when executed by one or more processors of the receiving device, may cause the receiving device to decode the plurality of spinal symbols.

Some aspects described herein relate to a transmitting device. The transmitting device may include a processing system. The processing system may include one or more processors and one or more code-storing memories coupled with the one or more processors. The processing system may be configured to cause the transmitting device to obtain a plurality of spinal symbols associated with a MIMO spinal code encoding scheme. The processing system may be configured to cause the transmitting device to map each spinal symbol of the plurality of spinal symbols to one or more transmission vectors of a plurality of transmission vectors of a MIMO transmission matrix based at least in part on a layer index within a resource element of a plurality of resource elements, and where at least one spinal symbol of the plurality of spinal symbols is mapped to at least a first layer and a second layer of a plurality of layers of the MIMO spinal code encoding scheme and at least to a first resource element and a second resource element of the plurality of resource elements in accordance with a repetition pattern. The processing system may be configured to cause the transmitting device to transmit the plurality of spinal symbols in accordance with the MIMO transmission matrix.

Some aspects described herein relate to a receiving device. The receiving device may include a processing system. The processing system may include one or more processors and one or more code-storing memories coupled with the one or more processors. The processing system may be configured to cause the receiving device to receive a plurality of spinal symbols associated with a MIMO spinal code encoding scheme, where each spinal symbol of the plurality of spinal symbols is mapped to one or more transmission vectors of a plurality of transmission vectors of a MIMO transmission matrix based at least in part on a layer index within a resource element of a plurality of resource elements, and where at least one spinal symbol of the plurality of spinal symbols is mapped to different layers of a plurality of layers of the MIMO spinal code encoding scheme and different resource elements of the plurality of resource elements in accordance with a repetition pattern. The processing system may be configured to cause the receiving device to decode the plurality of spinal symbols.

Some aspects described herein relate to an apparatus for wireless communication. The apparatus may include means for obtaining a plurality of spinal symbols associated with a MIMO spinal code encoding scheme. The apparatus may include means for mapping each spinal symbol of the plurality of spinal symbols to one or more transmission vectors of a plurality of transmission vectors of a MIMO transmission matrix based at least in part on a layer index within a resource element of a plurality of resource elements, and where at least one spinal symbol of the plurality of spinal symbols is mapped to at least a first layer and a second layer of a plurality of layers of the MIMO spinal code encoding scheme and at least to a first resource element and a second resource element of the plurality of resource elements in accordance with a repetition pattern. The apparatus may include means for transmitting the plurality of spinal symbols in accordance with the MIMO transmission matrix.

Some aspects described herein relate to an apparatus for wireless communication. The apparatus may include means for receiving a plurality of spinal symbols associated with a MIMO spinal code encoding scheme, where each spinal symbol of the plurality of spinal symbols is mapped to one or more transmission vectors of a plurality of transmission vectors of a MIMO transmission matrix based at least in part on a layer index within a resource element of a plurality of resource elements, and where at least one spinal symbol of the plurality of spinal symbols is mapped to different layers of a plurality of layers of the MIMO spinal code encoding scheme and different resource elements of the plurality of resource elements in accordance with a repetition pattern. The apparatus may include means for decoding the plurality of spinal symbols.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example associated with encoding of spinal codes.

FIG. 3 is a diagram illustrating an example associated with a rate matching or puncturing scheme for spinal codes.

FIG. 4 is a diagram illustrating an example of fixed rate spinal code.

FIGS. 5A and 5B are diagrams of examples associated with spinal coding schemes for MIMO wireless communications.

FIG. 5B shows an example associated with using a spinal encoder to encode a message into a vector of spinal symbols (such as the vector of spinal symbols described above in connection with the second operation and the third operation).

FIGS. 6A-6E are diagrams illustrating examples of spinal code MIMO aware repetitions.

FIG. 7 is a diagram illustrating an example process performed, for example, at a transmitting device or an apparatus of a transmitting device.

FIG. 8 is a diagram illustrating an example process performed, for example, at a receiving device or an apparatus of a receiving device.

FIG. 9 is a diagram of an example apparatus for wireless communication.

FIG. 10 is a diagram of an example apparatus for wireless communication.

### DETAILED DESCRIPTION

Binary coding schemes involve separately encoding and modulating a communication. Various types of binary codes are used in telecommunications. For example, New Radio (NR) physical downlink shared channel (PDSCH) uses binary low-density parity check (LDPC) code, NR physical downlink control channel (PDCCH) uses binary polar code, Long Term Evolution (LTE) PDSCH uses binary turbo code, LTE PDCCH uses binary convolution code, and so forth. However, binary codes can be less spectrally efficient than non-binary coding schemes, particularly for short block lengths. Non-binary codes, which involve jointly encoding and modulating a communication, offer an attractive tradeoff between performance and complexity.

Spinal codes are a class of Euclidean codes, which are typically rate-less codes that can handle time-varying channel conditions without requiring explicit bit rate selection. Spinal codes involve transmission at a higher rate than a channel can sustain followed by iterative re-transmission of information bits to lower the effective rate until a decoding success occurs (for example, until the receiver transmits an acknowledgment (ACK) or a negative acknowledgment (NACK)). More specifically, a transmitting device may perform the encoding once, and the channel rate may be changed based at least in part on the total quantity of channel uses. As used herein, a channel use may refer to a single instance of transmitting information via a channel. For example, a total quantity of channel uses may be a total quantity of times a communication channel is utilized to transmit information, which, in some examples, corresponds to a total quantity of resource elements (REs). By contrast, in other coding schemes, changing the channel rate is considered to be part of re-encoding the data. In some examples, a transmission of some or all of the resource elements and layers associated with a multiple input multiple output (MIMO) transmission (described in more detail below) may be performed in a single channel use.

In some examples, to ensure the reliability of a data communication (e.g., in scenarios such as at the cell edge or under severe fading conditions), one or more portions of the data communication may be transmitted with repetition. A communication transmitted with repetition may involve transmitting data (e.g., one or more portions of the communication) multiple times over distinct time or frequency domain resources to improve the likelihood that the data will be successfully received. However, transmitting a spinal code with repetition may increase a complexity associated with decoding the spinal code at a receiver (e.g., a wireless communication device that receives the transmitted spinal code).

Various aspects generally relate to wireless communications. Some aspects more specifically relate to spinal symbol repetition for MIMO spinal code encoding schemes. A transmitting device may obtain a plurality of spinal symbols associated with a MIMO spinal code encoding scheme. For example, the transmitting device may generate one or more spinal codes and may encode the one or more spinal codes to obtain a plurality of spinal symbols that can be transmitted over a channel. In some aspects, the transmitting device may map each spinal symbol to one or more transmission vectors of a MIMO transmission matrix. In these aspects, each transmission vector may correspond to a matrix element of the MIMO transmission matrix, and each matrix element may be associated with a single resource element and a single layer of the MIMO spinal code encoding scheme. In some aspects, there is a one-to-one relationship between a transmission vector and a matrix element. In these aspects, for each transmission vector, there may be a corresponding matrix element, and for each matrix element, there may be corresponding transmission vector.

In some aspects, at least one spinal symbol may be mapped to two or more transmission vectors of the MIMO transmission matrix. A spinal symbol that is mapped to two or more matrix elements may be referred to as a repetition symbol. In one example, the MIMO transmission matrix may have four layers and four resource elements. Therefore, the MIMO transmission matrix may have sixteen matrix elements corresponding to sixteen transmission vectors. In this example, the transmitting device may determine to transmit seven spinal symbols using the sixteen transmission vectors. Therefore, the transmitting device may transmit a subset of the spinal symbols multiple times such that two or more transmission vectors transmit the same symbol (for example, resulting in symbol repetition).

In some aspects, repetition symbols are to be equally spaced along layers while prioritizing repetitions in the highest layer within an RE. In these aspects, the repetition symbols are associated with different resource elements. For example, a spinal symbol may be transmitted twice, once on a first resource element and again on a second resource element.

Particular aspects of the subject matter described in this disclosure can be implemented to realize one or more of the following potential advantages. In some aspects, the described techniques can be used to enable spinal symbols to be mapped to a plurality of transmission vectors using spinal symbol repetition. In some aspects, by enabling the spinal symbols to be mapped to the plurality of transmission vectors using spinal symbol repetition, the described techniques can be used to increase spectral efficiency. In some aspects, by enabling the spinal symbols to be mapped to the plurality of transmission vectors using spinal symbol repetition, the described techniques can be used to increase a likelihood of data included in the spinal symbols being properly received by a receiving device.

In some aspects, by enabling the spinal symbols to be mapped to the plurality of transmission vectors using spinal symbol repetition, the described techniques can be used to reduce coding complexity. For example, the described techniques can be used to reduce computational complexity, energy consumption, and latency at both the encoder (for transmitting the spinal symbols) and at the decoder (for receiving the spinal symbols).

In some aspects, by enabling the spinal symbols to be mapped to the plurality of transmission vectors using spinal symbol repetition, the described techniques can be used to increase a signal-to-noise ratio (SNR) in the communications between the transmitting device and the receiving device. In some aspects, by transmitting the same spinal symbol in multiple transmission vectors (e.g., different transmission vectors of the same MIMO transmission matrix), the described techniques can be used to reduce demodulation and decoding complexity at a receiving device. In some aspects, by transmitting the same spinal symbol in the multiple transmission vectors of the MIMO transmission matrix, the described techniques can be used to increase a correlation between the repetition symbols. These example advantages, among others, are described in more detail below.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

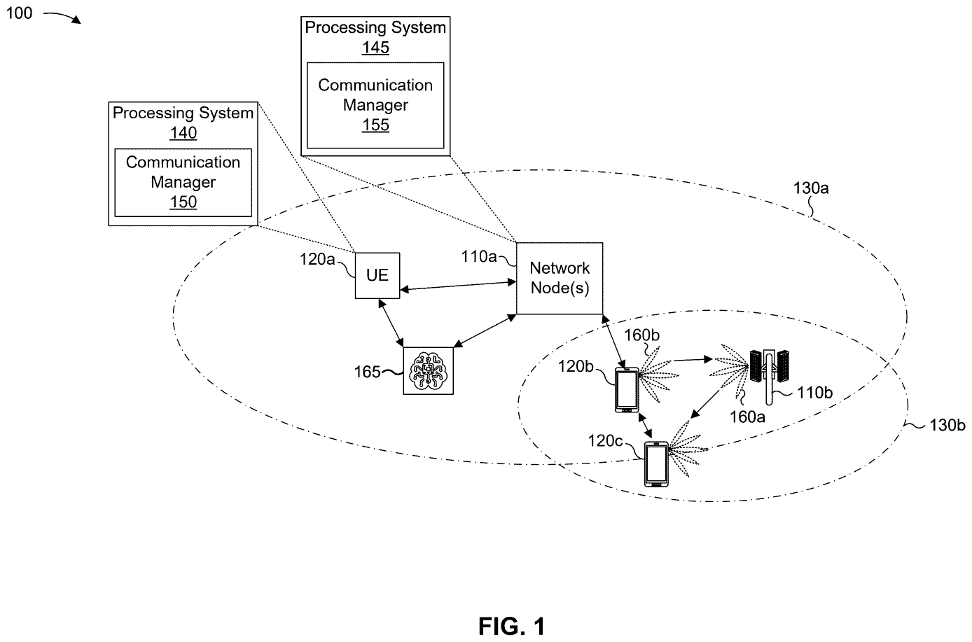

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple user equipments (UEs) 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ ACK indication or a HARQ NACK indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or an LDPC code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a transmitting device (e.g., a network node 110 or a UE 120) may include a communication manager 150 or a communication manager 155. As described in more detail elsewhere herein, the communication manager 150, 155 may obtain a plurality of spinal symbols associated with a MIMO spinal code encoding scheme; map each spinal symbol of the plurality of spinal symbols to one or more transmission vectors of a plurality of transmission vectors of a MIMO transmission matrix based at least in part on a layer index within a resource element of a plurality of resource elements, and wherein at least one spinal symbol of the plurality of spinal symbols is mapped to at least a first layer and a second layer of a plurality of layers of the MIMO spinal code encoding scheme and at least to a first resource element and a second resource element of the plurality of resource elements in accordance with a repetition pattern; and transmit the plurality of spinal symbols in accordance with the MIMO transmission matrix. Additionally, or alternatively, the communication manager 150, 155 may perform one or more other operations described herein.

In some aspects, a receiving device (e.g., a network node 110 or a UE 120) may include a communication manager 150 or a communication manager 155. As described in more detail elsewhere herein, the communication manager 150, 155 may receive a plurality of spinal symbols associated with a MIMO spinal code encoding scheme, wherein each spinal symbol of the plurality of spinal symbols is mapped to one or more transmission vectors of a plurality of transmission vectors of a MIMO transmission matrix based at least in part on a layer index within a resource element of a plurality of resource elements, and wherein at least one spinal symbol of the plurality of spinal symbols is mapped to different layers of a plurality of layers of the MIMO spinal code encoding scheme and different resource elements of the plurality of resource elements in accordance with a repetition pattern; and decode the plurality of spinal symbols. Additionally, or alternatively, the communication manager 150, 155 may perform one or more other operations described herein.

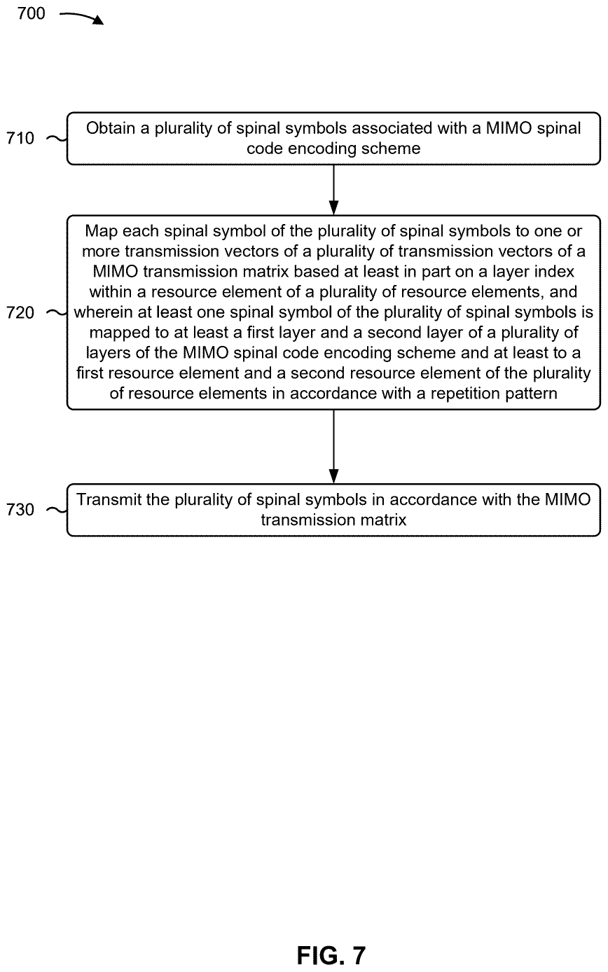

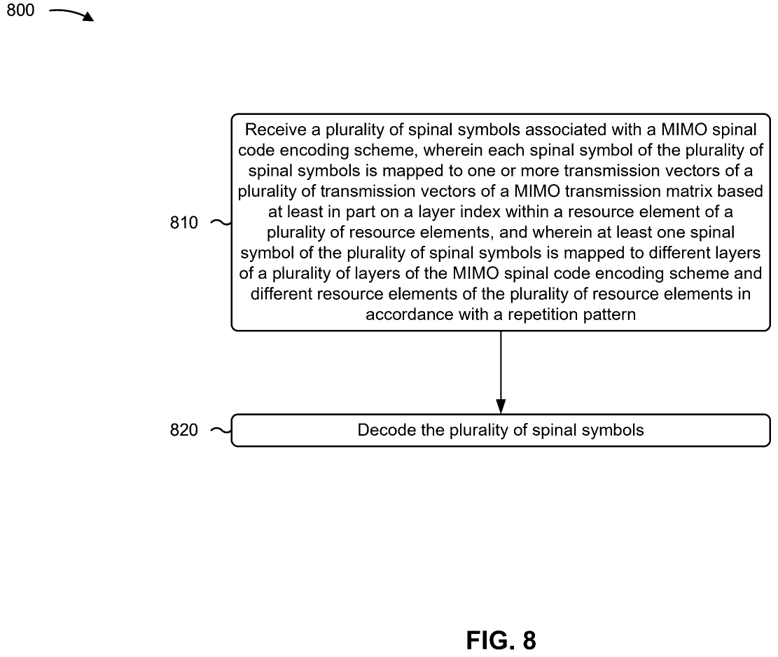

The network node 110, the processing system 145 of the network node 110, the UE 120, the processing system 140 of the UE 120, or any other component(s) of FIG. 1 may implement one or more techniques or perform one or more operations associated with spinal code MIMO aware repetitions, as described in more detail elsewhere herein. For example, the processing system 145 of the network node 110, or the processing system 140 of the UE 120 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 700 of FIG. 7, process 800 of FIG. 8, or other processes as described herein. In some examples, executing instructions may include running the instructions, converting the instructions, compiling the instructions, or interpreting the instructions, among other examples.

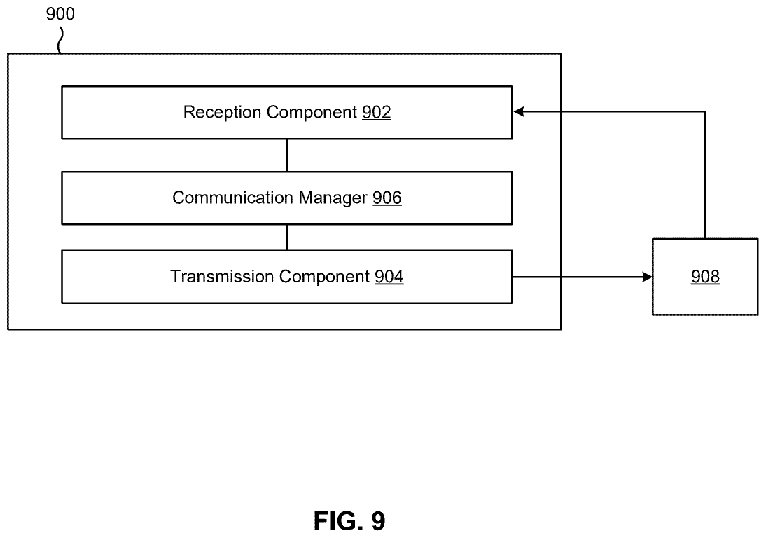

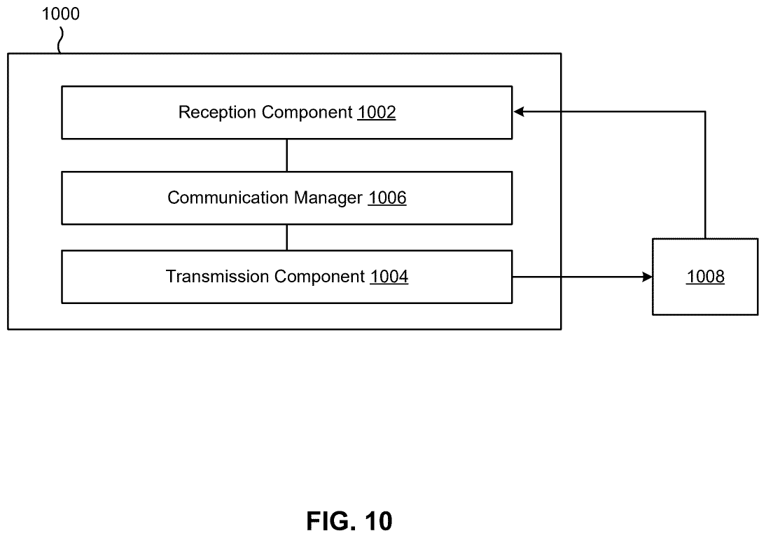

In some aspects, a transmitting device (e.g., a network node 110 or a UE 120) includes means for obtaining a plurality of spinal symbols associated with a MIMO spinal code encoding scheme; means for mapping each spinal symbol of the plurality of spinal symbols to one or more transmission vectors of a plurality of transmission vectors of a MIMO transmission matrix based at least in part on a layer index within a resource element of a plurality of resource elements, and wherein at least one spinal symbol of the plurality of spinal symbols is mapped to at least a first layer and a second layer of a plurality of layers of the MIMO spinal code encoding scheme and at least to a first resource element and a second resource element of the plurality of resource elements in accordance with a repetition pattern; or means for transmitting the plurality of spinal symbols in accordance with the MIMO transmission matrix. In some aspects, the means for the transmitting device to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples. In some aspects, the means for the transmitting device to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

In some aspects, a receiving device (e.g., a network node 110 or a UE 120) includes means for receiving a plurality of spinal symbols associated with a MIMO spinal code encoding scheme, wherein each spinal symbol of the plurality of spinal symbols is mapped to one or more transmission vectors of a plurality of transmission vectors of a MIMO transmission matrix based at least in part on a layer index within a resource element of a plurality of resource elements, and wherein at least one spinal symbol of the plurality of spinal symbols is mapped to different layers of a plurality of layers of the MIMO spinal code encoding scheme and different resource elements of the plurality of resource elements in accordance with a repetition pattern; or means for decoding the plurality of spinal symbols. In some aspects, the means for the receiving device to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples. In some aspects, the means for the receiving device to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

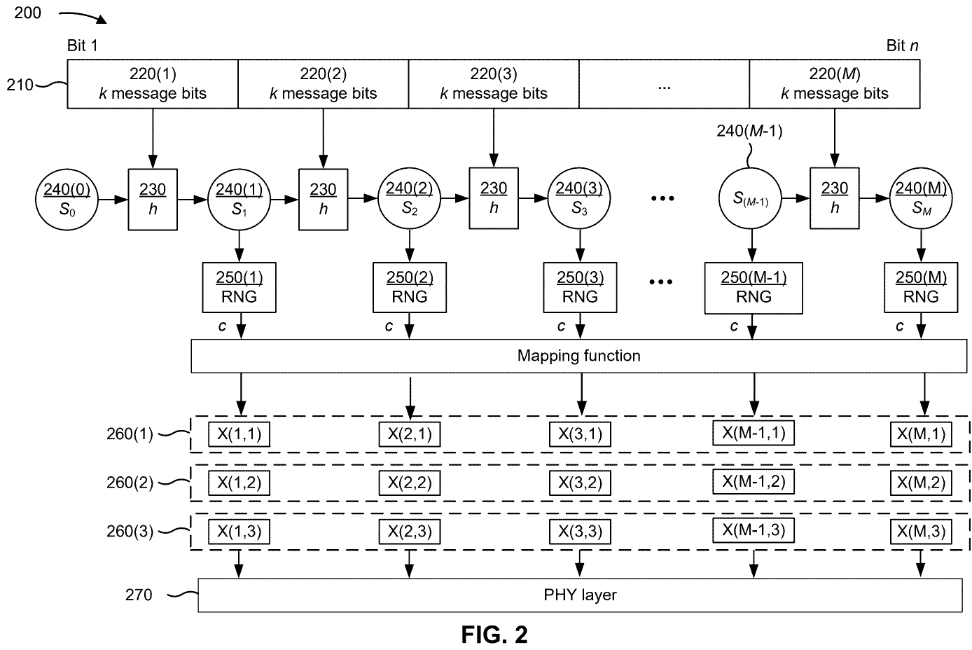

FIG. 2 is a diagram illustrating an example 200 associated with encoding of spinal codes.

As shown, a transmitting device may break up an input message 210 into blocks (or groups, chunks, or the like) of message bits 220(1)-220(M). The message may have a total of n bits, and each of the blocks of message bits 220(1)-220(M) may have a total of k bits. Thus, the total quantity of the blocks of message bits 220(1)-220(M) may be n/k (for example, M=n/k). The transmitting device may sequentially apply, to the blocks of message bits 220(1)-220(M), a hash function 230 (“h”). The hash function 230 may be designed such that a difference between two input messages in at least one bit results in a different coded sequence after the at least one bit, which may provide resilience to noise and bit errors.

The hash function 230 may also operate on v-bit states 240(0)-240(M−1), where v may be any suitable number (for example, 32). Thus, the hash function 230 may take two inputs: the blocks of message bits 220(1)-220(M) and the v-bit states 240(0)-240(M−1). The hash function 230 may output the v-bit states 240(1)-240(M) based at least in part on the blocks of message bits 220(1)-220(M) and the v-bit states 240(0)-240(M−1). In some examples, h:{0,1}^{v}×{0,1}^{k}→{0,1}^{v}. In some examples, Sᵢ=h(sᵢ₋₁, m̅ᵢ); s₀=0, where sᵢ is an i^{th} v-bit state 240(i) and m̅ᵢ is an i^{th} block of message bits 220(i).

For example, initially, the hash function 230 may take, as input, the block of message bits 220(1) and the v-bit state 240(0). The hash function 230 and the v-bit state 240(0) may be known to the transmitting device and the receiving device. In some examples, the v-bit state 240(0) may be zero (e.g., s₀=0). The hash function 230 may output the v-bit state 240(1), take, as input, the block of message bits 220(2) and the v-bit state 240(1), and output the v-bit state 240(2). This process may continue until the hash function 230 outputs the v-bit state 240(M). In this manner, the transmitting device may generate a “spine” of v bit states 240(1)-240(M) by sequentially hashing together the blocks of message bits 220(1)-220(M) from the input message 210 without adding redundancy bits.

The hash function 230 may provide the v-bit states 240(1)-240(M) as input (for example, seeds) to random number generators (RNGs) 250(1)-250(M). In some examples, the RNGs 250(1)-250(M) may be known to the transmitting device and the receiving device. The RNGs 250(1)-250(M) may generate sequences of random c-bit binary numbers: RNG: {0,1}^{v}× [symbol] →{0,1}^{c}. Thus, the transmitting device may randomly map the blocks of message bits 220(1)-220(M) to respective c-bit binary numbers. In some examples, a c-bit binary number may be a binary word that includes c bits. In some examples, the c-bit binary numbers may map to output IQ constellation symbols. For example, the transmitting device may use a mapping function to randomly select the output IQ constellation symbols. In this manner, the transmitting device may produce a sequence of coded bits and symbol for transmission. In some examples, the total quantity of the blocks of message bits 220(1)-220(M) may be equal to the total quantity of transmitted symbols.

In some examples, each of the RNGs 250(1)-250(M) may generate multiple sequences of random c-bit binary numbers. For example, in a first pass 260(1), the RNGs 250(1)-250(M) may generate first sequences of random c-bit binary numbers.

The transmitting device may, using the mapping function, convert the random c-bit binary numbers into first output IQ constellation symbols. The transmitting device may transmit, at a PHY layer 270, one or more samples corresponding to the first output IQ constellation symbols, and if the receiving device responds with a NACK, then the RNGs 250(1)-250(M) may, in a second pass 260(2), generate second sequences of random c-bit binary numbers. A sample may occupy a time window (for example, a slot) during which a transmitted signal has a given amplitude or phase corresponding to a given symbol (for example, a sample may encode a symbol). The transmitting device may, using the mapping function, convert the second sequences of random c-bit binary numbers into second output IQ constellation symbols. The transmitting device may transmit, at the PHY layer 270, one or more samples corresponding to the second output IQ constellation symbols, and if the receiving device responds with a NACK, then the RNGs 250(1)-250(M) may, in a third pass 260(3), generate third sequences of random c-bit binary numbers. The transmitting device may, using the mapping function, convert the third sequences of random c-bit binary numbers into third output IQ constellation symbols. The transmitting device may transmit, at the PHY layer 270, one or more samples corresponding to the third output IQ constellation symbols. This process may continue until the transmitting device receives an ACK from the receiving device or a timeout occurs. As used in FIG. 2, the notation “X(i,j)” refers to a j^{th} pass performed by a i^{th} RNG. Stated differently, “X(i,j)” refers to a QAM symbol that carries c[bits] from spine i with repetition j.

In some examples, the transmitting device may transmit one symbol per v-bit state per pass. Thus, if the receiving device takes l passes to decode the input message 210, then the effective rate is k/l bits per channel use, where k is the maximum rate.

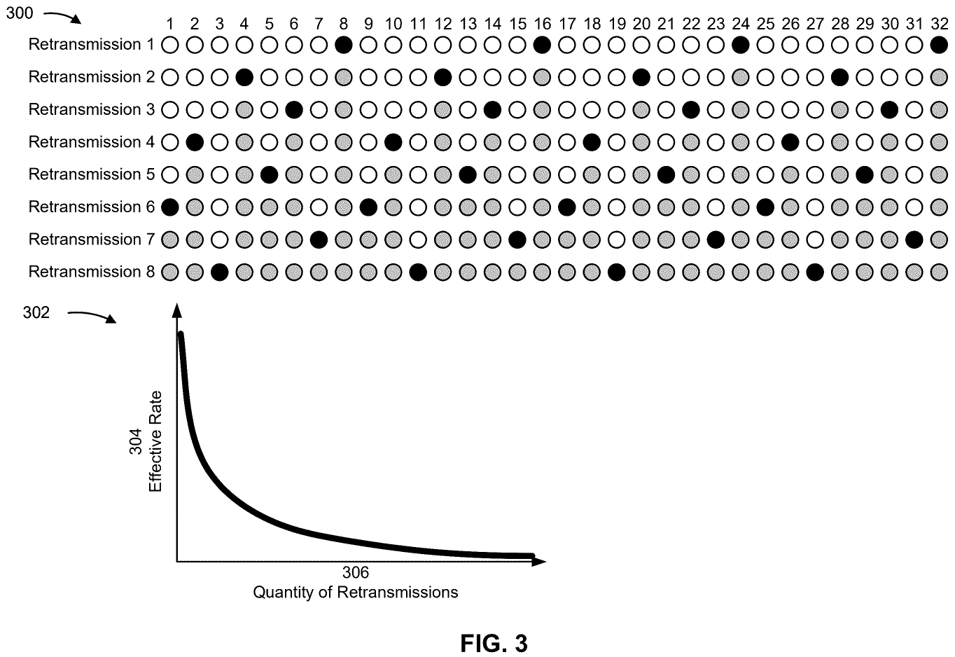

The receiving device (for example, decoder) may sequentially process the received samples until the input message 210 is successfully decoded or a timeout occurs. If the timeout occurs, then the transmitting device may proceed to a subsequent input message. This may be more readily understood with reference to FIG. 3.

FIG. 3 is a diagram illustrating an example 300 associated with a rate matching or puncturing scheme for spinal codes.

In the example 300, a transmitting device may transmit spinal symbols to a receiving device using a quantity of retransmissions (sometimes referred to as a quantity of sub-passes), indexed in FIG. 3 as retransmission 1 through retransmission 8 (but which may include more or fewer retransmissions in other examples). In each retransmission, the transmitting device transmits symbols for spine values marked by black circles, while grey circles indicate symbols that have already been transmitted (for example, in a previous retransmission). In such examples, choosing a quantity of transmitted symbols per retransmission may dictate a rate granularity for the spinal code.

More particularly, in an example in which 256 message bits are to be transmitted (for example, n=256), with each block of message bits (corresponding to each circle in FIG. 3) including eight bits (for example, k=8), the spinal code may be associated with 32 spines (for example, quantity of spines=n/k=32, as described above in connection with FIG. 2). In such an example, a quantity (for example, less than all) of the spinal codes may be transmitted in each retransmission. More particularly, in the first retransmission, the spinal symbols associated with spines indexed 8, 16, 24, and 32 may be transmitted, shown using black circles in connection with the row corresponding to retransmission 1. In the second retransmission, the spinal symbols associated with spines indexed 4, 12, 20, and 28 may be transmitted, shown using black circles in connection with the row corresponding to retransmission 2. Moreover, because the spinal symbols associated with spines indexed 8, 16, 24, and 32 may have previously been transmitted at this point in time (for example, in retransmission 1), those spinal symbols are shown using grey circles in retransmission 2. The transmitting device may continue to transmit spinal symbols in this manner until the message is successfully decoded by the receiving device or until all spinal symbols have been transmitted (for example, as shown in connection with retransmission 8).

Once the message is successfully decoded, the receiving device may transmit an acknowledgement message to the transmitting device, and the transmitting device may forgo transmitting any remaining retransmissions. In that regard, in some examples the spinal code may be considered “rate-less,” because a coding rate of the spinal code may not be set or may vary based on channel conditions, among other examples. For example, as shown in the plot 302, which includes an effective coding rate axis 304 and a quantity of retransmissions axis 306, an effective coding rate may decrease as a quantity of retransmissions used to transmit a message increases. For example, returning to the example described above, the spinal code may start a rate of 8 bits per channel use and may decrease in a manner consistent with the plot 302 as more retransmissions are used, with the total quantity of transmitted symbols per retransmission (for example, four in the above-described example 300) dictating the effective rate granularity. In some examples, using a spinal code as a rate-less code may enable use of the spinal code even in the absence of utilizing CSI-RSs or similar mechanisms for determining optimal transmission schemes (for example, optimal MCSs, among other examples).

In some other examples, a spinal code may be associated with a fixed rate (for example, the rate of the spinal code may be determined or fixed when encoding data), in a similar manner to LDPC codes or polar codes, among other examples. For example, a spinal code encoder may limit a quantity of spinal symbols generated or a transmitting device may transmit a fixed quantity of spinal symbols in a channel, thereby setting a fixed rate for the spinal code. In these examples, an MCS may determine a quantity of spinal symbols to be transmitted. Additionally or alternatively, spinal codes may be used in a similar manner as LDPC codes or polar codes, however, an MCS may be used to generate an equivalent rate matching or puncturing scheme for the spinal code, among other examples.

In some examples, a single-input, single output (SISO) rate matching or puncturing scheme may be defined as the mapping of the transmitted spinal symbols to the spines. In these examples, the rate matching or puncturing scheme may specify a code rate (e.g., a quantity of bits per channel use), which spines will be used to transmit a symbol, and a quantity of symbols to be transmitted from each spine.

In some examples, using spinal codes in MIMO-based wireless communication systems may reduce losses and thus reduce communication errors, resulting in more efficient communications. For example, in a 2×2 MIMO scheme using random precoding (for example, a MIMO scheme using two transmit antennas mapped to two layers and two receive antennas mapped to the two layers), polar codes or LDPC (for example, using a bit-interleaved coded modulation (BICM) scheme) codes may result in relatively large gap from a Shannon limit (a theoretical maximum rate at which information can be transmitted over a communication channel with a given bandwidth and noise level, while still being able to recover the original information with negligible errors), which may include shaping losses, coding losses (e.g., resulting from imperfect code), demodulator losses, alphabet losses, or log-likelihood ratio (LLR) calculation losses, among other examples. This relatively large gap from the Shannon limit may be due to the connections or correlations between the layers, which may not be accounted for by the BICM scheme

In some examples, using spinal codes in MIMO-based wireless communication systems may reduce losses and thus reduce communication errors, resulting in more efficient communications. For example, in a 2×2 MIMO scheme using random precoding (for example, a MIMO scheme using two transmit antennas mapped to two layers and two receive antennas mapped to the two layers), polar codes or LDPC (for example, using a bit-interleaved coded modulation (BICM) scheme) codes may result in an approximate 5 decibel (dB) gap from a Shannon limit (a theoretical maximum rate at which information can be transmitted over a communication channel with a given bandwidth and noise level, while still being able to recover the original information with negligible errors), which may include approximately 1.5 dB of shaping loss and approximately 1 dB of coding loss, as well as additional small losses such as demodulator losses, alphabet losses, or log-likelihood ratio (LLR) calculation losses, among other examples. In such an example, a potential gain of approximately 3.5 dB may be achieved using a better coded modulation scheme (for example, by using spinal codes rather than LDPC or polar codes). Similarly, for other MIMO scenarios the gain may be more significant. For example, for a 4×4 MIMO scenario using random precoding (for example, a MIMO scheme using four transmit antennas mapped to four layers and four receive antennas mapped to the four layers), a potential gain of approximately 4.5 dB may be achieved using a better coded modulation scheme (for example, by using spinal codes rather than LDPC or polar codes). In this regard, the potential gain (for example, the reduced gap from a Shannon limit) may increase with an increase in a quantity of layers.

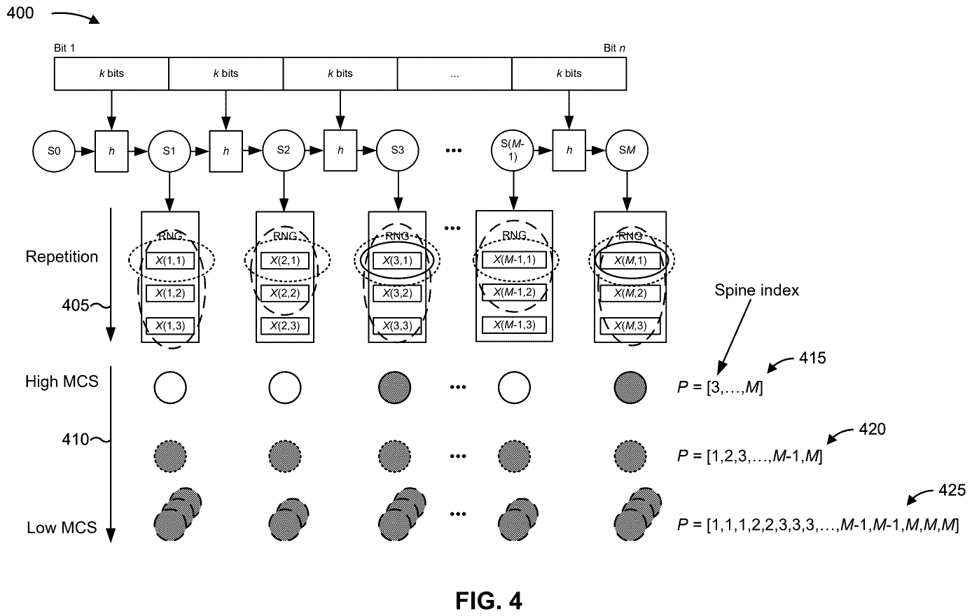

FIG. 4 is a diagram illustrating an example 400 of fixed rate spinal code.

In some examples, such as the example 400 shown in FIG. 4, a spinal code may be associated with a fixed rate (for example, the rate of the spinal code may be determined or fixed when encoding data), in a similar manner to LDPC codes or polar codes, among other examples. For example, a spinal code encoder may limit a quantity of spinal symbols generated or a transmitting device may transmit a fixed quantity of spinal symbols in a channel, thereby setting a fixed rate for the spinal code. Additionally, or alternatively, spinal codes may be used in a similar manner as LDPC codes or polar codes, however, an MCS may be used to generate an equivalent puncturing scheme for the spinal code, among other examples.

In some examples, as indicated by reference number 405, a spinal encoder may result in a quantity of repetitive symbols for each spine, in a similar manner as described above in connection with FIG. 2. In some examples, as indicated by reference number 410, an MCS may be used to generate an equivalent puncturing scheme for the spinal code, such as by using a puncturing scheme associated with relatively few spinal symbols when a high MCS is to be used, and by using a puncturing scheme associated with more spinal symbols when a low MCS is to be used. In this regard, when a spinal code is associated with a fixed rate, the puncturing scheme may specify a code rate (e.g., bits per channel use), which spines will be used to transmit a symbol, or a number of symbols to transmit for each spine. For example, as shown by reference number 415, when a high MCS is to be used, a puncturing scheme (P) may indicate that symbols associated with spine 3 and spine M are to be transmitted, and that no symbols from the other spines shown in FIG. 4 are to be transmitted (e.g., P=[3, . . . , M]). Accordingly, as shown using shaded circles in connection with reference number 415 and by using solid-line ellipses in connection with repetitive symbols indicated by reference number 410, one symbol associated with spine 3 (e.g., X(3,1)) and one symbol associated with spine M (e.g., X(M,1)) may be transmitted for this puncturing scheme or MCS. In some examples, as shown by using unshaded circles in connection with reference number 415 and by the absence of solid-line ellipses in connection with repetitive symbols indicated by reference number 410, no symbols associated with spines 1, 2, or M−1 are transmitted for this puncturing scheme or MCS.

As shown by reference number 420, when a lower MCS is to be used, a puncturing scheme may indicate that one symbol associated with each of spines 1, 2, 3, M−1, and M are to be transmitted (e.g., P=[1, 2, 3, . . . , M−1, M]). Accordingly, as shown using shaded circles in connection with reference number 420 and by using dotted-line ellipses in connection with repetitive symbols indicated by reference number 410, one symbol associated with spine 1 (e.g., X(1,1)), one symbol associated with spine 2 (e.g., X(2,1)), one symbol associated with spine 3 (e.g., X(3,1)), one symbol associated with spine M−1 (e.g., X(M−1,1)), and one symbol associated with spine M (e.g., X(M,1)) may be transmitted for this puncturing scheme or MCS.

As shown by reference number 425, when an even lower MCS is to be used, a puncturing scheme may indicate that multiple symbols (e.g., repetitive symbols) are to be transmitted for one or more spines. For example, a puncturing scheme may indicate that three symbols associated with each of spines 1, 3, and M are to be transmitted, and two symbols associated with each of spines 2 and M−1 are to be transmitted (e.g., P=[1, 1, 1, 2, 2, 3, 3, 3, . . . , M−1, M−1, M, M, M]). Accordingly, as shown using shaded circles in connection with reference number 420 and by using dashed-line ellipses in connection with repetitive symbols indicated by reference number 410, three symbol associated with spine 1 (e.g., X(1,1), X(1,2), and X(1,3)), two symbols associated with spine 2 (e.g., X(2,1) and X(2,2)), three symbol associated with spine 3 (e.g., X(3,1), X(3,2), and X(3,3)), two symbol associated with spine M−1 (e.g., X(M−1,1) and X(M−1,2)), and three symbols associated with spine M (e.g., X(M,1), X(M,2), and X(M,3)) may be transmitted for this puncturing scheme or MCS.

As indicated above, FIG. 4 is provided as an example. Other examples may differ from what is described with respect to FIG. 4.

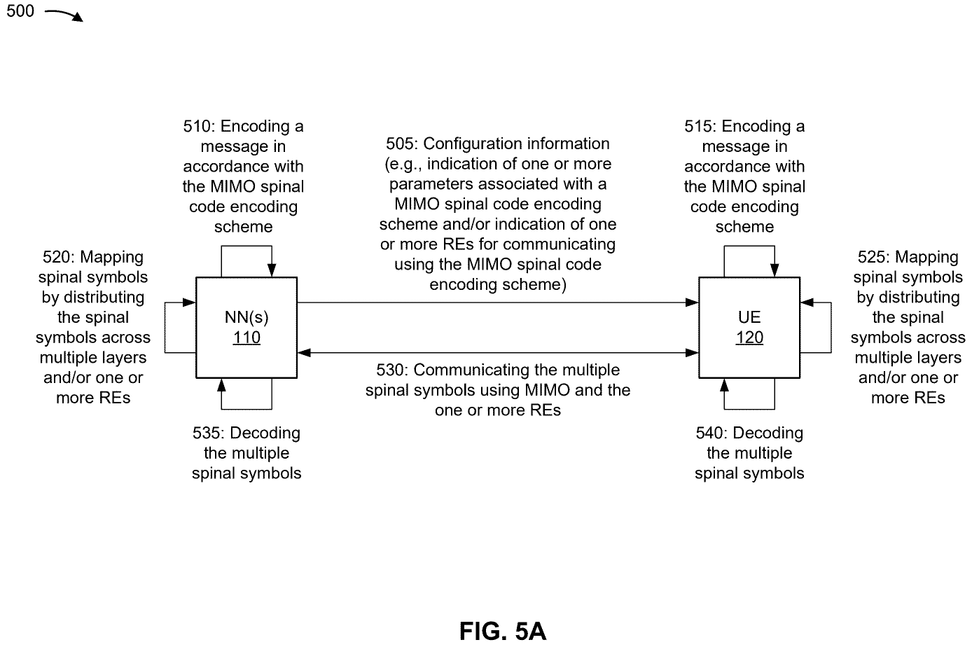

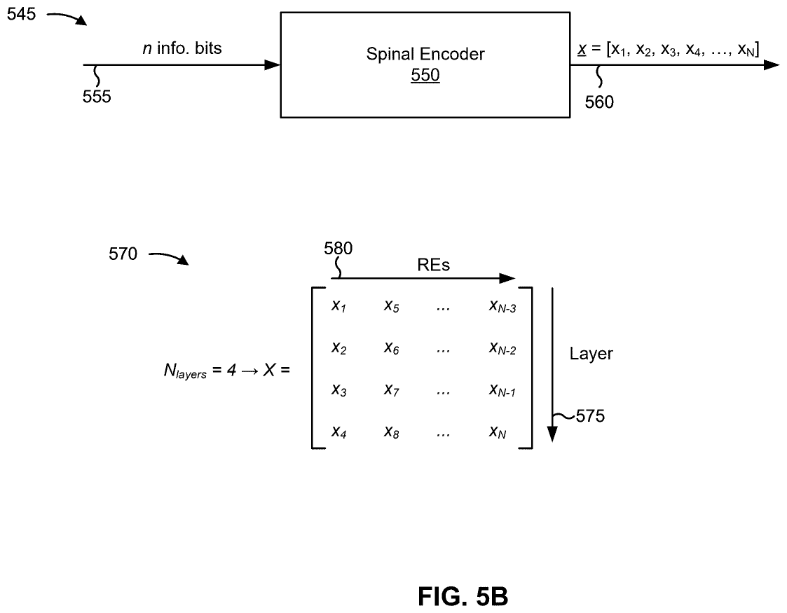

FIGS. 5A and 5B are diagrams of examples associated with spinal coding schemes for MIMO wireless communications. As shown in FIG. 5A, in example 500, a network node 110 may communicate with a UE 120. In some examples, the network node 110 and the UE 120 may be part of a wireless communication network (for example, wireless communication network 100). The UE 120 and the network node 110 may have established a wireless connection prior to operations shown in FIGS. 5A and 5B.

In some examples, the network node 110 and the UE 120 may be capable of communicating using spinal codes. In such examples, one of the network node 110 or the UE 120 may correspond to a transmitting device when the one of the network node 110 or the UE 120 is encoding messages using spinal codes and transmitting the messages to the other of the network node 110 or the UE 120, and thus the other of the network node 110 or the UE 120 may correspond to a receiving device.

In some examples, the network node 110 and the UE 120 may correspond to both a transmitting device and a receiving device. For example, the network node 110 may be a transmitting device, and thus the UE 120 may be a receiving device, for a first message (for example, the network node 110 may encode the first message using a spinal code and may transmit the encoded first message to the UE 120), the UE 120 may be a transmitting device, and thus the network node 110 may be a receiving device, for a second message (for example, the UE 120 may encode the second message using a spinal code and may transmit the encoded second message to the network node 110), and so forth.

In a first operation 505, the network node 110 may transmit, and the UE 120 may receive, configuration information. In some examples, the UE 120 may receive the configuration information via one or more of system information (for example, a master information block (MIB) or a system information block (SIB), among other examples), RRC signaling, one or more MAC CEs, or DCI, among other examples.

In some examples, the configuration information may indicate one or more candidate configurations or communication parameters. In some examples, the one or more candidate configurations or communication parameters may be selected, activated, or deactivated by a subsequent indication. For example, the subsequent indication may select a candidate configuration or communication parameter from the one or more candidate configurations or communication parameters. In some examples, the subsequent indication may include a dynamic indication, such as one or more MAC CEs or one or more DCI messages, among other examples.

In some examples, the configuration information may include an indication of one or more parameters associated with a MIMO spinal code encoding scheme and an indication of one or more REs for communicating using the MIMO spinal code encoding scheme. In such examples, the one or more parameters may indicate a quantity of spines (for example, a quantity of v bit states, as described above in connection with FIG. 2) associated with the MIMO spinal code encoding scheme, a quantity of the multiple spinal symbols to be encoded using the MIMO spinal code encoding scheme, a quantity of multiple transmit antennas to be used to transmit multiple spinal symbols (for example, symbols encoded using the MIMO spinal code encoding scheme), a quantity of multiple receive antennas to be used to receive the multiple spinal symbols, a quantity of the multiple layers associated with the MIMO spinal code encoding scheme, a quantity of one or more REs to be used to communicate the encoded message, or an indication of a MIMO puncturing scheme associated with the MIMO spinal code encoding scheme, among other examples.

In examples in which the configuration information indicates a MIMO puncturing scheme associated with the MIMO spinal code encoding scheme, the MIMO puncturing scheme may be associated with selectively transmitting spinal symbols associated with fewer than all spines of the multiple spines. Put another way, the MIMO puncturing scheme may indicate from which spines, of the multiple spines, spinal symbols are to be transmitted and how to map transmitted spinal symbols to the multiple layers and the one or more REs. In such examples, the configuration information may indicate which spinal symbols are to be transmitted and a total quantity of spinal symbols to be transmitted, among other information. Additionally or alternatively, the MIMO puncturing scheme may be associated with, for at least one spine of the multiple spines, transmitting multiple spinal symbols associated with the at least one spine (for example, the MIMO puncturing scheme may be associated with transmitting redundant spinal symbols). In such examples, the configuration information may indicate which spinal symbols are to be transmitted multiple times or a quantity of redundant symbols to be transmitted, among other information. Additionally or alternatively, the MIMO puncturing scheme may be associated with transmitting a first quantity of spinal symbols for a first spine and transmitting a second quantity of spinal symbols for a second spine, with the first quantity differing from the second quantity. In such examples, the configuration information may indicate the first and second quantities, among other information.

The UE 120 may configure itself based at least in part on the configuration information. In some examples, the UE 120 may be configured to perform one or more operations described herein based at least in part on the configuration information.

In some examples, the UE 120 may transmit, and the network node 110 may receive, capability information (for example, a capabilities report) (not shown). The capability information may indicate whether the UE 120 supports a feature and/or one or more parameters related to the feature. For example, the capability information may indicate a capability or parameter for communicating using spinal codes. As another example, the capability information may indicate a capability or parameter for communicating using a MIMO spinal code encoding scheme, such as the MIMO spinal code encoding scheme described herein (for example, a spinal code encoding scheme in which spinal codes are mapped to multiple layers and multiple REs). One or more operations described herein may be based on the capability information. For example, the UE 120 may perform a communication in accordance with the capability information, or may receive configuration information (for example, the configuration information described above in connection with the first operation 505) that is in accordance with the capability information.

In some examples, the configuration information described in connection with the first operation 505 or the capability information may include information transmitted via multiple communications. Additionally or alternatively, the network node 110 may transmit the configuration information, or a communication including at least a portion of the configuration information, before or after the UE 120 transmits the capability information. For example, the network node 110 may transmit a first portion of the configuration information before the capability information, the UE 120 may transmit at least a portion of the capability information, and the network node 110 may transmit a second portion of the configuration information after receiving the capability information.

In a second operation 510 or a third operation 515, the network node 110 or the UE 120, respectively, may encode a message in accordance with the configuration information, resulting in a vector that includes multiple spinal symbols. More particularly, in examples in which the network node 110 is the transmitting device and the UE 120 is the receiving device, at the second operation 510 the network node 110 may encode a message in accordance with the configuration information, resulting in a vector that includes multiple spinal symbols. Additionally or alternatively, in examples in which the UE 120 is the transmitting device and the network node 110 is the receiving device, at the third operation 515 the UE 120 may encode a message in accordance with the configuration information, resulting in a vector that includes multiple spinal symbols. Examples of encoding a message using a MIMO spinal code encoding scheme, resulting in a vector that includes multiple spinal symbols, are described in more detail below in connection with FIG. 5B and example 535.

In a fourth operation 520 or a fifth operation 525, the network node 110 or the UE 120, respectively, may map the multiple spinal symbols to multiple transmit antennas, such as by distributing the multiple spinal symbols across multiple layers associated with the multiple transmit antennas and across the one or more REs in accordance with the one or more parameters associated with the MIMO spinal code encoding scheme. More particularly, in examples in which the network node 110 is the transmitting device and the UE 120 is the receiving device, at the fourth operation 520 the network node 110 may map the multiple spinal symbols to multiple transmit antennas associated with the network node 110, such as by distributing the multiple spinal symbols across multiple layers associated with the multiple transmit antennas and across the one or more REs in accordance with the one or more parameters associated with the MIMO spinal code encoding scheme.

Additionally or alternatively, in examples in which the UE 120 is the transmitting device and the network node 110 is the receiving device, at the fifth operation 525 the UE 120 may map the multiple spinal symbols to multiple transmit antennas associated with the UE 120, such as by distributing the multiple spinal symbols across multiple layers associated with the multiple transmit antennas and across the one or more REs in accordance with the one or more parameters associated with the MIMO spinal code encoding scheme. In some examples, mapping the multiple spinal symbols to the multiple transmit antennas in accordance with the transmit matrix may include mapping the multiple layers to the multiple transmit antennas in accordance with a precoding matrix (for example, in accordance with a precoding matrix that converts layers to physical antennas). More particularly, as described above in connection with the second operation 510 and the third operation 515, the network node 110 or the UE 120, respectively, may encode the message, resulting in the vector that includes multiple spinal symbols.

Accordingly, in the fourth operation 520 or the fifth operation 525, the network node 110 or the UE 120, respectively, may map, using the precoding matrix (for example, a precoding matrix associated with random precoding, among examples) the vector into the transmit matrix. Examples of mapping multiple spinal symbols to multiple layers or one or more REs are described in more detail below in connection with FIG. 5B and example 560.

In a sixth operation 530, the network node 110 and the UE 120 may communicate the multiple spinal symbols using MIMO and the one or more REs (for example, the one or more REs indicated via the configuration information). More particularly, in examples in which the network node 110 is the transmitting device and the UE 120 is the receiving device, the network node 110 may transmit (for example, using multiple transmit antennas, one for each layer of the MIMO spinal code encoding scheme, and the one or more REs), and the UE 120 may receive (for example, using multiple receive antennas, one for each layer of the MIMO spinal code encoding scheme, and the one or more REs), the multiple spinal symbols. Additionally or alternatively, in examples in which the UE 120 is the transmitting device and the network node 110 is the receiving device, the UE 120 may transmit (for example, using multiple transmit antennas, one for each layer of the MIMO spinal code encoding scheme, and the one or more REs), and the network node 110 may receive (for example, using multiple receive antennas, one for each layer of the MIMO spinal code encoding scheme, and the one or more REs), the multiple spinal symbols.

In a seventh operation 535 or an eighth operation 540, the network node 110 or the UE 120, respectively, may decode the multiple spinal symbols, resulting in multiple message bits associated with the message. More particularly, in examples in which the network node 110 is the receiving device and the UE 120 is the transmitting device, at the seventh operation 535 the network node 110 may decode the multiple spinal symbols, resulting in multiple message bits associated with the message. Additionally or alternatively, in examples in which the UE 120 is the receiving device and the network node 110 is the transmitting device, at the eighth operation 540 the UE 120 may decode the multiple spinal symbols, resulting in multiple message bits associated with the message.

In some examples, decoding the multiple spinal symbols may include decoding the multiple spinal symbols using a multi-dimensional demodulator across the one or more REs. For example, the network node 110 (for example, in the seventh operation 535) or the UE 120 (for example, in the eighth operation 540) may decode the multiple spinal symbols by, for each RE, decoding a first spinal symbol associated with a first receive antenna, resulting in a first set of decoded message bits, and decoding a second spinal symbol associated with a second receive antenna using the first set of decoded message bits, resulting in a second set of decode message bits. In this way, the MIMO spinal code encoding schemes described herein may enable improved demodulation and/or decoding procedures as compared to demodulation or decoding procedures associated with LDPC codes or polar codes, among other examples. For example, the MIMO spinal code encoding schemes described herein may enable joint demodulation-decoding of a message, in the Euclidian domain, or may enable utilization of dependencies between the layers (for example, that came from the communication channel) to achieve improved spectral efficiency and low complexity.

FIG. 5B shows an example 545 associated with using a spinal encoder 550 to encode a message into a vector of spinal symbols (such as the vector of spinal symbols described above in connection with the second operation 510 and the third operation 515). The spinal encoder 550 may be located at a transmitting device (for example, one of the network node 110 or the UE 120) that is capable of encoding and transmitting messages using a MIMO spinal code encoding scheme or that is configured to encode and transmit messages using the MIMO spinal code encoding scheme. In a similar manner, as described above in connection with the second operation 510 and the third operation 515 of FIG. 5A, the spinal encoder 550 may be capable of encoding a message using a spinal code (for example, in accordance with the configuration information described above in connection with the first operation 505), resulting in a vector that includes multiple spinal symbols. For example, in examples in which the transmitting device is to transmit N spinal symbols, n information bits 555 may be encoded to N spinal symbols. More particularly, the n information bits 555 may be encoded, using the spinal encoder, to a transmit vector 560 (denoted as x in FIG. 5B) that includes N spinal symbols (for example, x=[x₁, x₂, x₃, x₄, . . . , x_{N}], with xi corresponding to a transmitted spinal symbol). In a similar manner, as described above in connection with the fourth operation 520 and the fifth operation 525, the transmit vector 560 may then be mapped to multiple layers and one or more REs associated with the MIMO spinal code encoding scheme.

For example, in some examples, the transmit vector 560 may be mapped to multiple layers and one or more REs in accordance with a transmit matrix 570 (sometimes referred to as X) or a precoding matrix. The transmit matrix 570 may have a size in a first dimension 575 corresponding to a quantity of layers of the MIMO spinal code encoding scheme (for example, a quantity of transmit antennas or receive antennas) and a size in a second dimension 580 corresponding to a quantity of the one or more REs. In such examples, for each RE in the transmit matrix 570, a subset of the multiple spinal symbols are sequentially ordered in the transmit matrix 570 in accordance with respective spine indexes associated with the subset of the multiple spinal symbols, with the subset of the multiple spinal symbols including a quantity of symbols that corresponds to the quantity of layers.

Put another way, mapping the transmit vector 560 (for example, x) to a quantity of transmit antennas (sometimes referred to herein as N_{TX}) or a quantity of REs (sometimes referred to herein as N_{RE}) may include splitting the transmit vector 560 into chunks corresponding to the quantity of layers (sometimes referred to as N_{layers}) and generating the transmit matrix 570 (for example, X), where

$$X ∈ {C}^{{N}_{TX} \times {N}_{RE}} , {N}_{RE} = \frac{N}{{N}_{layers}} ,$$

and N_{TX}=N_{layers} (assuming identity (for example, random) precoding). In that regard, in an example involving 4 layers (for example, N_{layers}=4, such as in examples involving 4×4 MIMO), a first column of the transmit matrix 570 (corresponding to a first configured RE) may include the first four spinal symbols of the transmit vector 560 (for example, x₁, x₂, x₃, and x₄), a second column of the transmit matrix 570 (corresponding to a second configured RE) may include the next four spinal symbols of the transmit vector 560 (for example, x₅, x₆, x₇, and x₈), and so forth through a last column of the transmit matrix 570 (corresponding to a last configured RE) that may include the last four spinal symbols of the transmit vector 550 (for example, x_{N-3}, x_{N-2}, x_{N-1}, and x_{N}). The transmit matrix 570 (for example, X) may then be transmitted from the transmitting device (for example, one of the network node 110 or the UE 120) through a matrix channel (sometimes referred to as H, where

$$H ∈ {C}^{{N}_{RE} \times {N}_{RX} \times {N}_{TX}} )$$

receiving device (for example, the other one of the network node 110 or the UE 120). Accordingly, the received matrix at the receiving device (sometimes referred to as Y, where

$$Y ∈ {C}^{{N}_{RE} \times {N}_{RX}} )$$

may be Y=HX+N (with “N” in this expression corresponding to noise in the channel). The received matrix (for example, Y) may then be decoded at the receiving device to retrieve the message bits (for example, the n information bits 545).

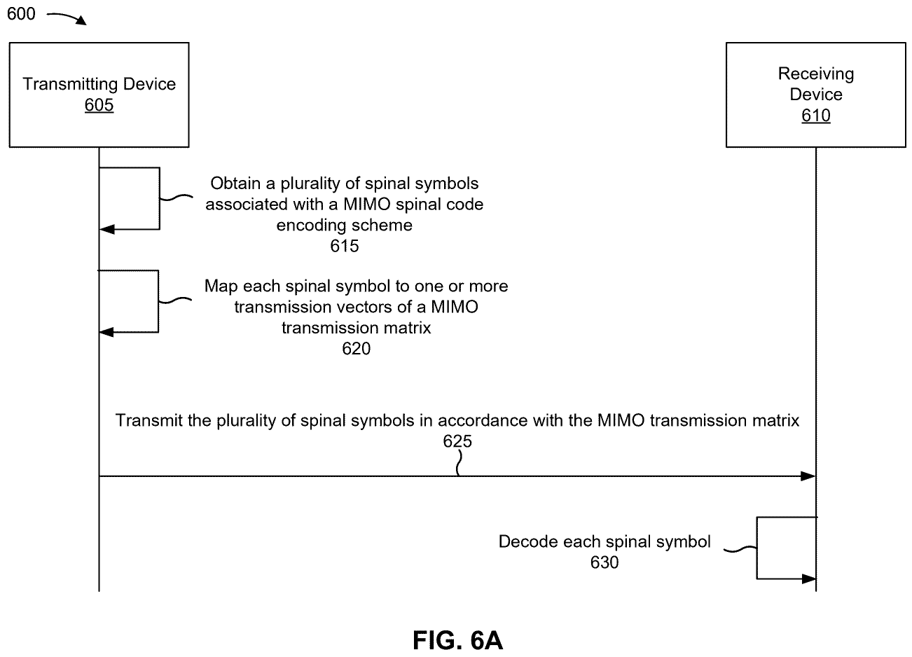

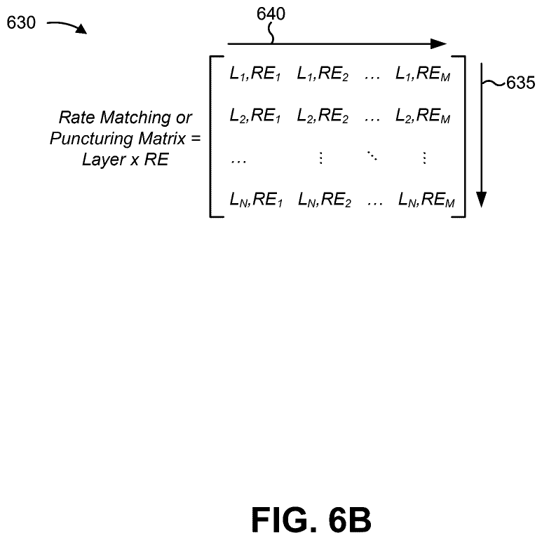

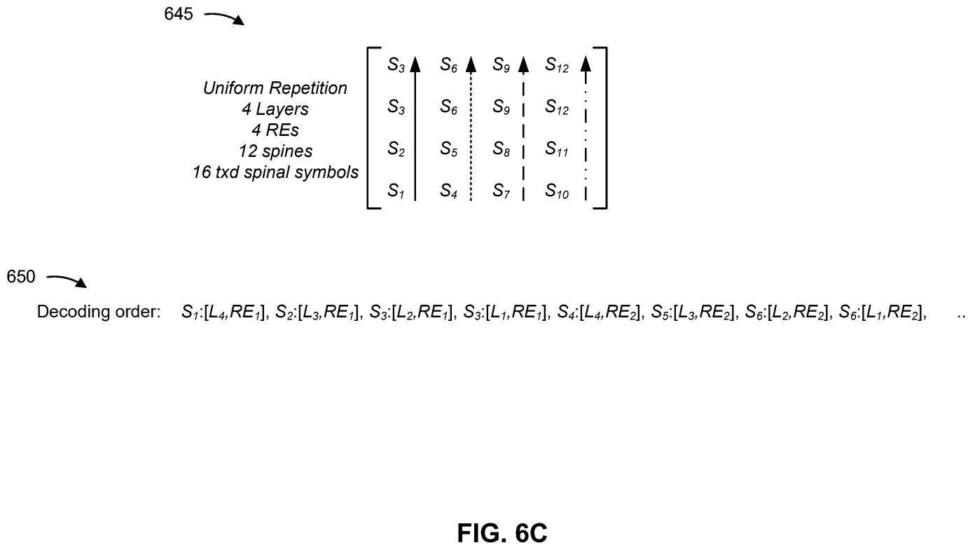

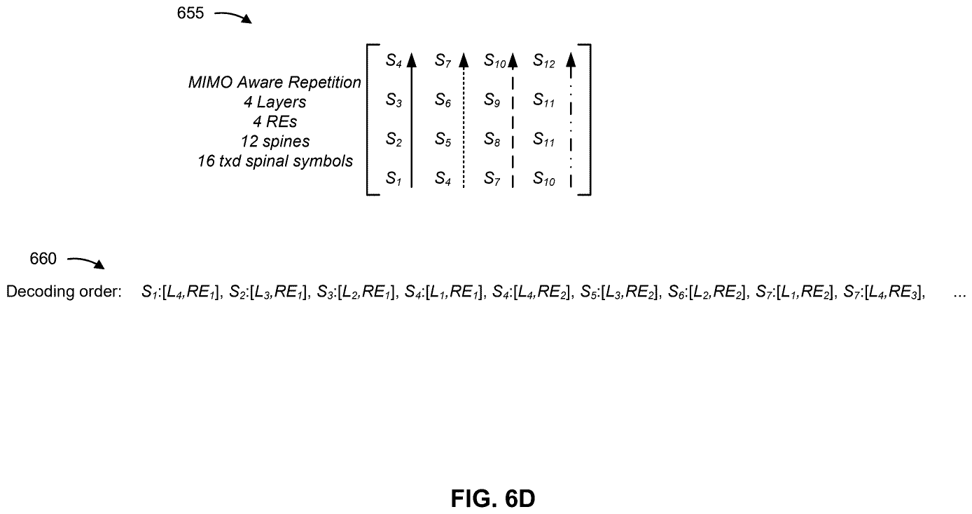

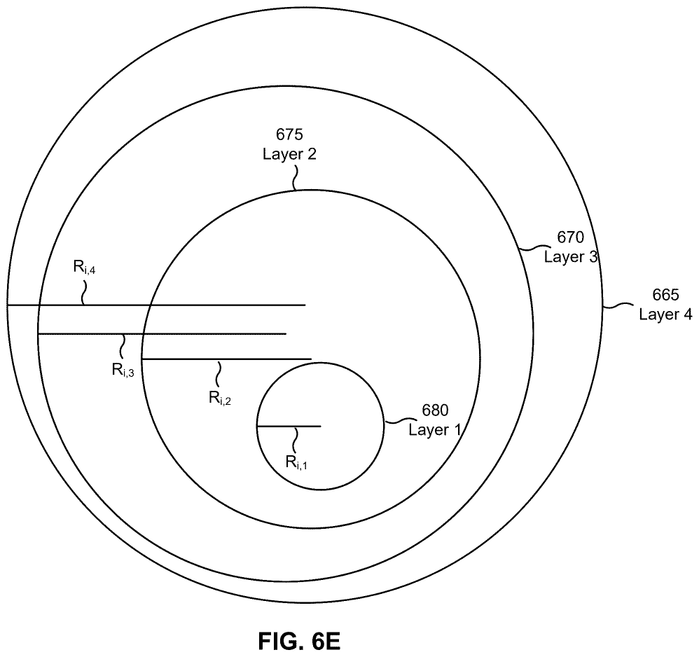

FIGS. 6A-6E are diagrams illustrating examples of spinal code MIMO aware repetitions.

As shown in FIG. 6A and example 600, a transmitting device 605 may communicate with a receiving device 610. In some aspects, the transmitting device 605 may be the network node 110. In some other aspects, the transmitting device 605 may be the UE 120. In some aspects, the receiving device 610 may be the UE 120. In some other aspects, the receiving device 610 may be the network node 110.

As shown by reference number 615, the transmitting device 605 may obtain a plurality of spinal symbols associated with a MIMO spinal code encoding scheme. In some aspects, the transmitting device 605 may obtain the plurality of spinal symbols associated with the MIMO spinal code encoding scheme using an encoder, such as the spinal encoder 550 described in connection with FIG. 5B.

As shown by reference number 620, the transmitting device 605 may map each spinal symbol of the plurality of spinal symbols to one or more transmission vectors of a plurality of transmission vectors of a MIMO transmission matrix. In some aspects, each transmission vector may correspond to a matrix element of a plurality of matrix elements of the MIMO transmission matrix. In some aspects, each matrix element may be associated with a single resource element and a single layer. In these aspects, at least one spinal symbol of the plurality of spinal symbols is mapped to two or more transmission vectors of the plurality of transmission vectors of the MIMO transmission matrix.

In some aspects, a transmission vector may be a resource element that carries one or more layers. In some aspects, the plurality of spinal symbols may be mapped to the plurality of transmission vectors in ascending order with respect to the plurality of resource elements and in descending order with respect to the plurality of layers.

In some aspects, at least one spinal symbol of the plurality of spinal symbols may be mapped to two or more matrix elements. In some aspects, the two or more matrix elements may be associated with different resource elements of the plurality of resource elements. In some aspects, the two or more matrix elements may be non-adjacent matrix elements.

In some aspects, mapping each spinal symbol to the one or more transmission vectors may include mapping each spinal symbol to the one or more transmission vectors in accordance with a MIMO rate matching or puncturing scheme. The MIMO rate matching or puncturing scheme may indicate one or more spines of a plurality of spines of the MIMO spinal code encoding scheme from which spinal symbols are to be transmitted. Additionally or alternatively, the MIMO rate matching or puncturing scheme may indicate one or more spines of a plurality of spines of the MIMO spinal code encoding scheme from which spinal symbols are not to be transmitted. In some aspects, the MIMO rate matching or puncturing scheme may indicate one or more parameters for mapping the plurality of spinal symbols to the plurality of resource elements and the plurality of layers.

As shown by reference number 625, the transmitting device 605 may transmit the plurality of spinal symbols in accordance with the MIMO transmission matrix. In some aspects, transmitting the plurality of spinal symbols in accordance with the MIMO transmission matrix may include transmitting the plurality of spinal symbols from a subset of spines of a plurality of spines associated with the MIMO spinal code encoding scheme. In these aspects, transmitting the plurality of spinal symbols may include transmitting two or more spinal symbols from at least one spine of the subset of spines associated with the MIMO spinal code encoding scheme. Additionally or alternatively, transmitting the plurality of spinal symbols in accordance with the MIMO transmission matrix comprises transmitting a first quantity of spinal symbols associated with a first spine of a plurality of spines and transmitting a second quantity of spinal symbols associated with a second spine of the plurality of spines, wherein the first quantity is different than the second quantity.

As shown in FIG. 6B, a rate matching or puncturing matrix 630 may be used to map spinal symbols to transmit antennas (for example, layers) and REs in accordance with a MIMO rate matching or puncturing scheme. The order of the rate matching or puncturing matrix 630 may correspond to the quantity of layers in a first dimension 635 by a quantity of REs in a second dimension 640. For example, in aspects in which the puncturing matrix 630 is associated with N layers and M REs, a first column of the rate matching or puncturing matrix 630 may include a symbol associated with a first of the N layers and a first of the M REs (shown using the notation L₁, RE₁) through a symbol associated with an N^{th} of the N layers and the first of the M REs (shown using the notation L_{N}, RE₁). Similarly, a second column of the puncturing matrix 630 may include a symbol associated with the first of the N layers and a second of the M REs (shown using the notation L₁, RE₂) through a symbol associated with the N^{th} of the N layers and the second of the M REs (shown using the notation L_{N}, RE₂). This pattern may generally repeat through a last column (for example, an M^{th} column) of the puncturing matrix 630, which may include a symbol associated with the first of the N layers and an M^{th} of the M REs (shown using the notation L₁, RE_{M}) through a symbol associated with the N^{th} of the N layers and the M^{th} of the M REs (shown using the notation L_{N}, RE_{M}).

In some aspects, as shown in FIG. 6C, encoded spinal symbols may be mapped to the rate matching or puncturing matrix 630 in accordance with a MIMO rate matching or puncturing scheme that uses uniform repetition symbols (for example, where repetition symbols are located on the same resource element and are equally spaced apart). The rate matching or puncturing matrix 645 shows one example of mapping spinal symbols (denoted as Sᵢ, where i corresponds to a spine index, such as an index associated with one of the v bit states described above in connection with FIG. 2) to four layers and four REs. In this example, the message may be encoded using twelve spines (for example, the spinal code may be associated with a total of twelve v bit states) and the encoded message may be transmitted using sixteen transmitted spinal symbols (for example, x=x₁, x₂, . . . , x₁₆ in this example). In such examples, because the quantity of transmitted spinal symbols (for example, sixteen) exceeds the quantity of spines (for example, twelve), the transmitting device 605 may transmit the spinal symbols in accordance with a MIMO rate matching puncturing scheme in which at least some spinal symbols are transmitted multiple times, such as for a purpose of transmitting redundant symbols and improving a decoding process at the receiving device 610.

In some aspects, a symbol associated with the first spine (for example, S₁) may be transmitted once, using a fourth layer and a first RE (for example, using position L₄, RE₁ of the rate matching or puncturing matrix 645). In some aspects, a symbol associated with the third spine (for example, S₃) may be transmitted twice, using a second layer and a first RE (for example, using position L₂, RE₁ of the rate matching or puncturing matrix 645) as well as a first layer and a first RE (for example, using position L₁, RE₁ of the rate matching or puncturing matrix 645).

Additionally, a symbol associated with the fourth spine (for example, S₄) and a symbol associated with the fifth spine (for example, S₅) may be transmitted once, using a fourth layer and a second RE (for example, using position L₄, RE₂ of the rate matching or puncturing matrix 645) and a third layer and a second RE (for example, using position L₃, RE₂ of the rate matching or puncturing matrix 645), respectively.

In some aspects, a symbol associated with the sixth spine (for example, S₆) may be transmitted twice, using a second layer and a second RE (for example, using position L₂, RE₂ of the rate matching or puncturing matrix 645) as well as a first layer and a second RE (for example, using position L₁, RE₂ of the rate matching or puncturing matrix 645). In some aspects, a symbol associated with the seventh spine (for example, S₇) and a symbol associated with the eighth spine (for example, S₈) may be transmitted once, using a fourth layer and a third RE (for example, using position L₄, RE₃ of the rate matching or puncturing matrix 645) and a third layer and a third RE (for example, using position L₃, RE₃ of the rate matching or puncturing matrix 645), respectively.

In some aspects, a symbol associated with the ninth spine (for example, S₉) may be transmitted twice, using a second layer and a third RE (for example, using position L₂, RE₃ of the rate matching or puncturing matrix 645) as well as a first layer and a third RE (for example, using position L₁, RE₃ of the rate matching or puncturing matrix 645). In some aspects, a symbol associated with the tenth spine (for example, S₁₀) and a symbol associated with the eleventh spine (for example, S₁₁) may be transmitted once, using a fourth layer and a fourth RE (for example, using position L₄, RE₄ of the rate matching or puncturing matrix 645) and a third layer and a fourth RE (for example, using position L₃, RE₄ of the rate matching or puncturing matrix 645), respectively. In some aspects, a symbol associated with the twelfth spine (for example, S₁₂) may be transmitted twice, using a second layer and a fourth RE (for example, using position L₂, RE₄ of the rate matching or puncturing matrix 645) as well as a first layer and a fourth RE (for example, using position L₁, RE₄ of the rate matching or puncturing matrix 645).

In some aspects, a decoding process at a receiving device 610 may be performed spine by spine, with respect to the order of the spines in the rate matching or puncturing matrix 645. For example, decoding order 650 depicts how a receiving device 610 may decode spinal symbols transmitted in accordance with the puncturing matrix 645. In some aspects, as indicated by the solid arrow shown in connection with the column of the puncturing matrix 645 corresponding to the first RE, after receiving the transmitted spinal symbols in the first RE (for example, using multiple receive antennas), the receiving device 610 may first decode the symbol associated with the first spine (for example, S₁), followed by the symbol associated with the second spine (for example, S₂), followed by the two symbols associated with the third spine (for example, S₃).

In some aspects, after receiving the transmitted spinal symbols in the second RE, the receiving device 610 may first decode the symbol associated with the fourth spine (for example, S₄), followed by the symbol associated with the fifth spine (for example, S₅), and then followed by the two symbols associated with the sixth spine (for example, S₆). In some aspects, after receiving the transmitted spinal symbols in the third RE, the receiving device 610 may first decode the symbol associated with the seventh spine (for example, S₇), followed by the symbol associated with the eighth spine (for example, S₈), followed by the two symbols associated with the ninth spine (for example, S₉). In some aspects, after receiving the transmitted spinal symbols in the fourth RE, the receiving device 610 may first decode the symbol associated with the tenth spine (for example, S₁₀), followed by the symbol associated with the eleventh spine (for example, S₁₁), and then followed by the two symbols associated with the twelfth spine (for example, S₁₂).

In some aspects, as shown in FIG. 6D, encoded spinal symbols may be mapped to the rate matching or puncturing matrix 630 in accordance with a MIMO rate matching or puncturing scheme that uses MIMO aware repetitions (for example, where repetition symbols are located on different resource elements). The rate matching or puncturing matrix 655 shows one example of mapping spinal symbols (denoted as Sᵢ, where i corresponds to a spine index, such as an index associated with one of the v bit states described above in connection with FIG. 2) to four layers and four REs. In this example, the message may be encoded using twelve spines (for example, the spinal code may be associated with a total of twelve v bit states) and the encoded message may be transmitted using sixteen transmitted spinal symbols (for example, x=x₁, x₂, . . . , x₁₆ in this example). In such examples, because the quantity of transmitted spinal symbols (for example, sixteen) exceeds the quantity of spines (for example, twelve), the transmitting device 605 may transmit the spinal symbols in accordance with a MIMO aware rate matching or puncturing scheme in which at least some spinal symbols are transmitted multiple times, such as for a purpose of transmitting redundant symbols or improving a decoding process at the receiving device 610.

In some aspects, a symbol associated with the first spine (for example, S₁) may be transmitted once, using a fourth layer and a first RE (for example, using position L₄, RE₁ of the rate matching or puncturing matrix 655), a symbol associated with the second spine (for example, S₂) may be transmitted once, using a third layer and a first RE (for example, using position L₃, RE₁ of the rate matching or puncturing matrix 655), and a symbol associated with the third spine (for example, S₃) may be transmitted once, using a second layer and a first RE (for example, using position L₂, RE₁ of the rate matching or puncturing matrix 655). In some aspects, a symbol associated with the fourth spine (for example, S₄) may be transmitted twice, using a first layer and a first RE (for example, using position L₁, RE₁ of the rate matching or puncturing matrix 655) and a fourth layer and a second RE (for example, using position L₄, RE₂ of the rate matching or puncturing matrix 655).

In some aspects, a symbol associated with the fifth spine (for example, S₅) may be transmitted once, using a third layer and a second RE (for example, using position L₃, RE₂ of the rate matching or puncturing matrix 655) and a symbol associated with the sixth spine (for example, S₆) may be transmitted once, using a second layer and a second RE (for example, using position L₂, RE₂ of the rate matching or puncturing matrix 655). In some aspects, a symbol associated with the seventh spine (for example, S₇) may be transmitted twice, using a first layer and a second RE (for example, using position L₁, RE₂ of the rate matching or puncturing matrix 655) and a fourth layer and a third RE (for example, using position L₄, RE₃ of the rate matching or puncturing matrix 655).

In some aspects, a symbol associated with the eighth spine (for example, S₈) may be transmitted once, using a third layer and a third RE (for example, using position L₃, RE₃ of the rate matching or puncturing matrix 655) and a symbol associated with the ninth spine (for example, S₉) may be transmitted once, using a second layer and a third RE (for example, using position L₂, RE₃ of the rate matching or puncturing matrix 655). In some aspects, a symbol associated with the tenth spine (for example, S₁₀₇) may be transmitted twice, using a first layer and a third RE (for example, using position L₁, RE₃ of the rate matching or puncturing matrix 655) and a fourth layer and a fourth RE (for example, using position L₄, RE₄ of the rate matching or puncturing matrix 655).

In some aspects, the transmitting device 605 may determine that the fourth RE is a last RE via which the symbols are to be transmitted and that all of the REs are associated with a repetition of a symbol. In these aspects, the transmitting device 605 may utilize an adjacent repetition method.

In some aspects, the transmitting device 605 may prioritize a higher layer for repetition. For example, the transmitting device 605 may prioritize repetition of a symbol transmitted using a third layer over a symbol transmitted using a second layer. As shown in FIG. 6D, based at least in part on prioritizing a higher layer for repetition, a symbol associated with the eleventh spine (for example, S₁₁) may be transmitted twice, using a third layer and a fourth RE (for example, using position L₃, RE₄ of the rate matching or puncturing matrix 655) and a second layer and a fourth RE (for example, using position L₂, RE₄ of the rate matching or puncturing matrix 655) and a symbol associated with the twelfth spine (for example, S₁₂) may be transmitted once, using a first layer and a fourth RE (for example, using position L₁, RE₄ of the rate matching or puncturing matrix 655).

In some aspects, a decoding process at a receiving device 610 may be performed spine by spine, with respect to the order of the spines in the rate matching or puncturing matrix 655. For example, decoding order 660 depicts how the receiving device 610 may decode spinal symbols transmitted in accordance with the puncturing matrix 655. In some aspects, after receiving the spinal symbols transmitted by the transmitting device 605, the receiving device 610 may decode the symbol associated with the first spine (for example, Sᵢ located at position L₄, RE₁ of the rate matching or puncturing matrix 655), followed by the symbol associated with the second spine (for example, S₂ located at position L₃, RE₁ of the rate matching or puncturing matrix 655), followed by the symbol associated with the third spine (for example, S₃ located at position L₂, RE₁ of the puncturing matrix 655), followed by the two symbols associated with the fourth spine (for example, S₄ located at positions L₁, RE₁ and L₄, RE₂ of the rate matching or puncturing matrix 655).

In some aspects, the receiving device 610 may decode the symbol associated with the fifth spine (for example, Ss located at position L₃, RE₂ of the rate matching or puncturing matrix 655), followed by the symbol associated with the sixth spine (for example, S₇ located at position L₂, RE₂ of the rate matching or puncturing matrix 655), followed by the two symbols associated with the seventh spine (for example, S₇ located at positions L₁, RE₂ and L₄, RE₃ of the rate matching or puncturing matrix 655). In some aspects, the receiving device 610 may decode the symbol associated with the eighth spine (for example, Ss located at position L₃, RE₃ of the rate matching or puncturing matrix 655), followed by the symbol associated with the ninth spine (for example, S₉ located at position L₂, RE₃ of the rate matching or puncturing matrix 655), followed by the two symbols associated with the tenth spine (for example, S₁₀ located at positions L₁, RE₃ and L₄, RE₄ of the rate matching or puncturing matrix 655), followed by the two symbols associated with the eleventh spine (for example, S₁₁ located at positions L₃, RE₄ and L₂, RE₄ of the rate matching or puncturing matrix 655), followed by the symbol associated with the twelfth spine (for example, S₁₂ located at position L₁, RE₄ of the rate matching or puncturing matrix 655).

In some aspects, the receiving device 610 may decode the received symbols (for example, the noisy symbols), such as by finding a valid sequence of encoded symbols that matches the received symbols within a certain threshold of noise tolerance. In this regard, a hypothesis of each decoded symbol may be used in decoding subsequent spinal symbols. Put another way, in some aspects, decoding the multiple spinal symbols includes, for each RE, decoding a first spinal symbol, of the multiple spinal symbols, associated with a first receive antenna, of the multiple receive antennas, resulting in a first set of decoded message bits, and decoding a second spinal symbol, of the multiple spinal symbols, associated with a second receive antenna, of the multiple receive antennas, resulting in a second set of decoded message bits, where decoding the second spinal symbol includes decoding the second spinal symbols using the first set of decoded message bits. For example, returning to the example rate matching or puncturing matrix 655, the receiving device 610 may first attempt to decode a symbol associated with the first spine (for example, S₁) and then may use the decoded message bits in attempting to decode a symbol associated with the second spine (for example, S₂), and so forth.

In some aspects, because the spines associated with the repetition symbols are separated into different REs, the MIMO aware repetitions may not permit column permutations in the H matrix before decomposing the H matrix into Q and R. As an example, r_{i,j} may represent a radius of a sphere and B_{i,j} may represent a quantity of hypotheses in the j th layer of the i th RE. In some aspects, the total quantity of hypotheses may be proportional to the volume or multiplication of the radiuses r_{i,1}, r_{i,2}, r_{i,3}, r_{i,4}.

In some aspects, after QR decomposition of the i th RE, a relationship between the radiuses may be r_{i,1}<r_{i,2}<r_{i,3}<r_{i,4} (e.g., the first layer has the largest radius and the last layer has a very small radius). Although this relationship between the radiuses occurs in most cases, there may be instances in which the relationship between one or more of the radiuses differs from the relationship described above. In either case, by utilizing repetitions across two different layers, the set of hypotheses can be reduced by the intersection of the hypothesis.

For example, as shown in FIG. 6E, a set of hypotheses for a fourth layer of an RE may be represented by a radius/volume of a sphere 665, a set of hypotheses for a third layer of an RE may be represented by a radius/volume of a sphere 670, a set of hypotheses for a second layer of an RE may be represented by a radius/volume of a sphere 675, and a set of hypotheses for a first layer of an RE may be represented by a radius/volume of a sphere 680. A portion of sphere 670 that overlaps with sphere 665 may represent a set of hypotheses for a symbol that is transmitted with repetitions across the fourth and third layers of an RE.

Therefore, to maximize the reduction in hypotheses resulting from transmitting a symbol with repetitions, the transmitting device 605 may prioritize lower layers over higher layers. For example, transmitting a symbol via a first layer of a first RE and a fourth layer of a second RE reduces the set of hypotheses from a quantity of hypothesis represented by the volume of the sphere 665 to a quantity of hypothesis represented by a portion of sphere 680 that intersects with the sphere 665.

In some aspects, the MIMO aware repetition scheme described above may result in repetitions being spread uniformly across a transmission matrix while prioritizing repetitions in the last spine (first layer) within an RE such that the repetitions will cross REs. Further, in some aspects, the quantity of repetitions may be larger than the quantity of REs, which may result in each RE having a repetition that starts with a previous RE (or ends with a subsequent RE). In these aspects, the MIMO aware repetition scheme may prioritize lower spines (higher layers), for example, as shown and described with respect to FIG. 6D.

As indicated above, FIGS. 6A-6E are provided as an example. Other examples may differ from what is described with respect to FIGS. 6A-6E.

FIG. 7 is a diagram illustrating an example process 700 performed, for example, at a transmitting device or an apparatus of a transmitting device. Example process 700 is an example where the apparatus or the transmitting device (e.g., transmitting device 605) performs operations associated with spinal code MIMO aware repetitions.

As shown in FIG. 7, in some aspects, process 700 may include obtaining a plurality of spinal symbols associated with a MIMO spinal code encoding scheme (block 710). For example, the transmitting device (e.g., using reception component 902 or communication manager 906, depicted in FIG. 9) may obtain a plurality of spinal symbols associated with a MIMO spinal code encoding scheme, as described above.

As further shown in FIG. 7, in some aspects, process 700 may include mapping each spinal symbol of the plurality of spinal symbols to one or more transmission vectors of a plurality of transmission vectors of a MIMO transmission matrix based at least in part on a layer index within a resource element of a plurality of resource elements, and wherein at least one spinal symbol of the plurality of spinal symbols is mapped to at least a first layer and a second layer of a plurality of layers of the MIMO spinal code encoding scheme and at least to a first resource element and a second resource element of the plurality of resource elements in accordance with a repetition pattern (block 720). For example, the transmitting device (e.g., using communication manager 906, depicted in FIG. 9) may map each spinal symbol of the plurality of spinal symbols to one or more transmission vectors of a plurality of transmission vectors of a MIMO transmission matrix based at least in part on a layer index within a resource element of a plurality of resource elements, and wherein at least one spinal symbol of the plurality of spinal symbols is mapped to at least a first layer and a second layer of a plurality of layers of the MIMO spinal code encoding scheme and at least to a first resource element and a second resource element of the plurality of resource elements in accordance with a repetition pattern, as described above. In some aspects, each transmission vector of the plurality of transmission vectors corresponds to a matrix element of a plurality of matrix elements of the MIMO transmission matrix, each matrix element of the plurality of matrix elements being associated with a single resource element of a plurality of resource elements of the MIMO spinal code encoding scheme and a single layer of a plurality of layers of the MIMO spinal code encoding scheme. In some aspects, at least one spinal symbol of the plurality of spinal symbols is mapped to at least a first layer and a second layer of the plurality of layers and at least to a first resource element and a second resource element of the plurality of resource elements in accordance with a repetition pattern.

As further shown in FIG. 7, in some aspects, process 700 may include transmitting the plurality of spinal symbols in accordance with the MIMO transmission matrix (block 730). For example, the transmitting device (e.g., using transmission component 904 or communication manager 906, depicted in FIG. 9) may transmit the plurality of spinal symbols in accordance with the MIMO transmission matrix, as described above.

Process 700 may include additional aspects, such as any single aspect or any combination of aspects described below or in connection with one or more other processes described elsewhere herein.

In a first aspect, the repetition pattern includes repetitions that are distributed equally spaced along spines and prioritizing repetitions in a highest spine number within a given resource element to cause the repetition to occur across a pair of resource elements, or the repetition pattern includes a quantity of the repetitions that is greater than a quantity of resource elements, of the plurality of resource elements, wherein the given resource element includes a first repetition that ends in a lowest spine number within the given resource element and begins in highest spine number in a previous resource element, and wherein the given resource element includes a second repetition in a next two lowest spine numbers in the given resource element.

In a second aspect, alone or in combination with the first aspect, a spinal symbol transmitted via a last resource element, of the plurality of resource elements, is transmitted with repetitions via the last resource element.

In a third aspect, alone or in combination with one or more of the first and second aspects, the at least one spinal symbol is mapped to a first transmission vector of the plurality of transmission vectors of the MIMO transmission matrix and a second transmission vector of the plurality of transmission vectors of the MIMO transmission matrix, the first transmission vector being associated with the first resource element and the first layer and the second transmission vector being associated with the second resource element and the second layer, wherein the second resource element is different from the first resource element and the second layer is different from the first layer.

In a fourth aspect, alone or in combination with one or more of the first through third aspects, the plurality of spinal symbols are mapped to the plurality of transmission vectors in ascending order with respect to the plurality of resource elements and in descending order with respect to the plurality of layers.

In a fifth aspect, alone or in combination with one or more of the first through fourth aspects, the first layer is associated with a first noise radius and the second layer is associated with a second noise radius, wherein the first noise radius is smaller than the second noise radius.

In a sixth aspect, alone or in combination with one or more of the first through fifth aspects, the first layer is a last layer to which the plurality of spinal symbols are mapped for the first resource element and the second layer is a first layer to which the plurality of spinal symbols are mapped for the second resource element.

In a seventh aspect, alone or in combination with one or more of the first through sixth aspects, the first transmission vector corresponds to a first matrix element of the plurality of matrix elements and the second transmission vector corresponds to a second matrix element of the plurality of matrix elements, and wherein the first matrix element and the second matrix element are non-adjacent matrix elements within the MIMO transmission matrix.

In an eighth aspect, alone or in combination with one or more of the first through seventh aspects, the repetition pattern is configured to reduce a hypothesis space associated with decoding the at least one spinal symbol during a decoding process.

In a ninth aspect, alone or in combination with one or more of the first through eighth aspects, a rate matching scheme associated with mapping each spinal symbol of the plurality of spinal symbols to the one or more transmission vectors indicates a code rate, a set of spines of the MIMO spinal encoding scheme to be used for transmission of the plurality of spinal symbols, and a quantity of symbols associated with each spine of the set of spines.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a receiving device or an apparatus of a receiving device. Example process 800 is an example where the apparatus or the receiving device (e.g., receiving device 610) performs operations associated with spinal code MIMO aware repetitions.

As shown in FIG. 8, in some aspects, process 800 may include receiving a plurality of spinal symbols associated with a MIMO spinal code encoding scheme, wherein each spinal symbol of the plurality of spinal symbols is mapped to one or more transmission vectors of a plurality of transmission vectors of a MIMO transmission matrix based at least in part on a layer index within a resource element of a plurality of resource elements, and wherein at least one spinal symbol of the plurality of spinal symbols is mapped to different layers of a plurality of layers of the MIMO spinal code encoding scheme and different resource elements of the plurality of resource elements in accordance with a repetition pattern (block 810). For example, the receiving device (e.g., using reception component 1002 or communication manager 1006, depicted in FIG. 10) may receive a plurality of spinal symbols associated with a MIMO spinal code encoding scheme, wherein each spinal symbol of the plurality of spinal symbols is mapped to one or more transmission vectors of a plurality of transmission vectors of a MIMO transmission matrix based at least in part on a layer index within a resource element of a plurality of resource elements, and wherein at least one spinal symbol of the plurality of spinal symbols is mapped to different layers of a plurality of layers of the MIMO spinal code encoding scheme and different resource elements of the plurality of resource elements in accordance with a repetition pattern, as described above. In some aspects, each spinal symbol of the plurality of spinal symbols is mapped to one or more transmission vectors of a plurality of transmission vectors of a MIMO transmission matrix in accordance with a rate matching scheme that is based at least in part on a layer index within a resource element of a plurality of resource elements, wherein each transmission vector of the plurality of transmission vectors corresponds to a matrix element of a plurality of matrix elements of the MIMO transmission matrix, each matrix element of the plurality of matrix elements being associated with a single resource element of a plurality of resource elements of the MIMO spinal code encoding scheme and a single layer of a plurality of layers of the MIMO spinal code encoding scheme, and wherein at least one spinal symbol of the plurality of spinal symbols is mapped to different layers of the plurality of layers and different resource elements of the plurality of resource elements in accordance with a repetition pattern.

As further shown in FIG. 8, in some aspects, process 800 may include decoding the plurality of spinal symbols (block 820). For example, the receiving device (e.g., using communication manager 1006, depicted in FIG. 10) may decode the plurality of spinal symbols, as described above.

Process 800 may include additional aspects, such as any single aspect or any combination of aspects described below or in connection with one or more other processes described elsewhere herein.

In a first aspect, the repetition pattern includes repetitions that are distributed equally spaced along spines and prioritizing repetitions in a highest spine number within a resource element to cause the repetition to occur across a pair of resource elements.

In a second aspect, alone or in combination with the first aspect, a spinal symbol transmitted via a last resource element, of the plurality of resource elements, is transmitted with repetitions via the last resource element.

In a third aspect, alone or in combination with one or more of the first and second aspects, the at least one spinal symbol is mapped to a first transmission vector of the plurality of transmission vectors of the MIMO transmission matrix and a second transmission vector of the plurality of transmission vectors of the MIMO transmission matrix, the first transmission vector being associated with the first resource element and the first layer and the second transmission vector being associated with the second resource element and the second layer, the second resource element is different from the first resource element and the second layer t is different from the first layer.

In a fourth aspect, alone or in combination with one or more of the first through third aspects, the plurality of spinal symbols are mapped to the plurality of transmission vectors in ascending order with respect to the plurality of resource elements and in descending order with respect to the plurality of layers.

In a fifth aspect, alone or in combination with one or more of the first through fourth aspects, the first layer is associated with a smaller noise radius relative to the second layer.

In a sixth aspect, alone or in combination with one or more of the first through fifth aspects, the first layer is a last layer to which the plurality of spinal symbols are mapped for the first resource element and the second layer is a first layer to which the plurality of spinal symbols are mapped for the second resource element.

In a seventh aspect, alone or in combination with one or more of the first through sixth aspects, decoding the plurality of spinal symbols comprises utilizing a first hypothesis space associated with decoding the at least one spinal symbol mapped to the first layer of the first resource element to reduce a second hypothesis space associated with decoding the at least one spinal symbol mapped to the second layer of the second resource element.

In an eighth aspect, alone or in combination with one or more of the first through seventh aspects, the first transmission vector corresponds to a first matrix element of the plurality of matrix elements and the second transmission vector corresponds to a second matrix element of the plurality of matrix elements, and wherein the first matrix element and the second matrix element are non-adjacent matrix elements within the MIMO transmission matrix.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a transmitting device (e.g., a network node 110 or a UE 120), or a transmitting device may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 or the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 or processing system 145 described in connection with FIG. 1) of the transmitting device.

In some aspects, the apparatus 900 may be configured to perform one or more operations described herein in connection with FIGS. 2-4, 5A, 5B, and 6A-6E. Additionally, or alternatively, the apparatus 900 may be configured to perform one or more processes described herein, such as process 700 of FIG. 7. In some aspects, the apparatus 900 or one or more components shown in FIG. 9 may include one or more components of the transmitting device described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the transmitting device described above in connection with FIG. 1, such as a radio, one or more RF chains, one or more transceivers, or one or more modems, each of which may in turn be coupled with one or more antennas of the transmitting device.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the transmitting device described above in connection with FIG. 1, such as a radio, one or more RF chains, one or more transceivers, or one or more modems, each of which may in turn be coupled with one or more antennas of the transmitting device described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The reception component 902 may obtain a plurality of spinal symbols associated with a MIMO spinal code encoding scheme. The communication manager 906 may map each spinal symbol of the plurality of spinal symbols to one or more transmission vectors of a plurality of transmission vectors of a MIMO transmission matrix in accordance with a rate matching scheme that is based at least in part on a layer index within a resource element of a plurality of resource elements wherein each transmission vector of the plurality of transmission vectors corresponds to a matrix element of a plurality of matrix elements of the MIMO transmission matrix, each matrix element of the plurality of matrix elements being associated with a single resource element of a plurality of resource elements of the MIMO spinal code encoding scheme and a single layer of a plurality of layers of the MIMO spinal code encoding scheme, and wherein at least one spinal symbol of the plurality of spinal symbols is mapped to at least a first layer and a second layer of the plurality of layers and at least to a first resource element and a second resource element of the plurality of resource elements in accordance with a repetition pattern. The transmission component 904 may transmit the plurality of spinal symbols in accordance with the MIMO transmission matrix.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a receiving device (e.g., a network node 110 or a UE 120), or a receiving device may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 150 or the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 or the processing system 145 described in connection with FIG. 1) of the receiving device.

In some aspects, the apparatus 1000 may be configured to perform one or more operations described herein in connection with FIGS. 2-4, 5A, 5B, and 6A-6E. Additionally, or alternatively, the apparatus 1000 may be configured to perform one or more processes described herein, such as process 800 of FIG. 8. In some aspects, the apparatus 1000 or one or more components shown in FIG. 10 may include one or more components of the receiving device described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the receiving device described above in connection with FIG. 1, such as a radio, one or more RF chains, one or more transceivers, or one or more modems, each of which may in turn be coupled with one or more antennas of the receiving device.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the receiving device described above in connection with FIG. 1, such as a radio, one or more RF chains, one or more transceivers, or one or more modems, each of which may in turn be coupled with one or more antennas of the receiving device described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The reception component 1002 may receive a plurality of spinal symbols associated with a MIMO spinal code encoding scheme wherein each spinal symbol of the plurality of spinal symbols is mapped to one or more transmission vectors of a plurality of transmission vectors of a MIMO transmission matrix in accordance with a rate matching scheme that is based at least in part on a layer index within a resource element of a plurality of resource elements, wherein each transmission vector of the plurality of transmission vectors corresponds to a matrix element of a plurality of matrix elements of the MIMO transmission matrix, each matrix element of the plurality of matrix elements being associated with a single resource element of a plurality of resource elements of the MIMO spinal code encoding scheme and a single layer of a plurality of layers of the MIMO spinal code encoding scheme, and wherein at least one spinal symbol of the plurality of spinal symbols is mapped to different layers of the plurality of layers and different resource elements of the plurality of resource elements in accordance with a repetition pattern. The communication manager 1006 may decode the plurality of spinal symbols.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a transmitting device, comprising: obtaining a plurality of spinal symbols associated with a MIMO spinal code encoding scheme; mapping each spinal symbol of the plurality of spinal symbols to one or more transmission vectors of a plurality of transmission vectors of a MIMO transmission matrix in accordance with a rate matching scheme that is based at least in part on a layer index within a resource element of a plurality of resource elements, wherein each transmission vector of the plurality of transmission vectors corresponds to a matrix element of a plurality of matrix elements of the MIMO transmission matrix, each matrix element of the plurality of matrix elements being associated with a single resource element of a plurality of resource elements of the MIMO spinal code encoding scheme and a single layer of a plurality of layers of the MIMO spinal code encoding scheme, and wherein at least one spinal symbol of the plurality of spinal symbols is mapped to at least a first layer and a second layer of the plurality of layers and at least to a first resource element and a second resource element of the plurality of resource elements in accordance with a repetition pattern; and transmitting the plurality of spinal symbols in accordance with the MIMO transmission matrix.

Aspect 2: The method of Aspect 1, wherein the repetition pattern includes repetitions that are distributed equally spaced along spines and prioritizing repetitions in a highest spine number within a resource element to cause the repetition to occur across a pair of resource elements.

Aspect 3: The method of any of Aspects 1-2, wherein a spinal symbol transmitted via a last resource element, of the plurality of resource elements, is transmitted with repetitions via the last resource element.

Aspect 4: The method of any of Aspects 1-3, wherein the at least one spinal symbol is mapped to a first transmission vector of the plurality of transmission vectors of the MIMO transmission matrix and a second transmission vector of the plurality of transmission vectors of the MIMO transmission matrix, the first transmission vector being associated with a first resource element of the plurality of resource elements and a first layer of the plurality of layers and the second transmission vector being associated with a second resource element of the plurality of resource elements that is different from the first resource element and a second layer of the plurality of layers that is different from the first layer.

Aspect 5: The method of Aspect 4, wherein the plurality of spinal symbols are mapped to the plurality of transmission vectors in ascending order with respect to the plurality of resource elements and in descending order with respect to the plurality of layers.

Aspect 6: The method of Aspect 5, wherein the first layer is associated with a first noise radius and the second layer is associated with a second noise radius, wherein the first noise radius is smaller than the second noise radius.

Aspect 7: The method of Aspect 5, wherein the first layer is a last layer to which the plurality of spinal symbols are mapped for the first resource element and the second layer is a first layer to which the plurality of spinal symbols are mapped for the second resource element.

Aspect 8: The method of Aspect 4, wherein the first transmission vector corresponds to a first matrix element of the plurality of matrix elements and the second transmission vector corresponds to a second matrix element of the plurality of matrix elements, and wherein the first matrix element and the second matrix element are non-adjacent matrix elements within the MIMO transmission matrix.

Aspect 9: The method of any of Aspects 1-8, wherein the repetition pattern is configured to reduce a hypothesis space associated with decoding the at least one spinal symbol during a decoding process.

Aspect 10: The method of any of Aspects 1-9, wherein the rate matching scheme indicates a code rate, a set of spines of the MIMO spinal encoding scheme to be used for transmission of the plurality of spinal symbols, and a quantity of symbols associated with each spine of the set of spines.

Aspect 11: A method of wireless communication performed by a receiving device, comprising: receiving a plurality of spinal symbols associated with a MIMO spinal code encoding scheme, wherein each spinal symbol of the plurality of spinal symbols is mapped to one or more transmission vectors of a plurality of transmission vectors of a MIMO transmission matrix in accordance with a rate matching scheme that is based at least in part on a layer index within a resource element of a plurality of resource elements, wherein each transmission vector of the plurality of transmission vectors corresponds to a matrix element of a plurality of matrix elements of the MIMO transmission matrix, each matrix element of the plurality of matrix elements being associated with a single resource element of a plurality of resource elements of the MIMO spinal code encoding scheme and a single layer of a plurality of layers of the MIMO spinal code encoding scheme, and wherein at least one spinal symbol of the plurality of spinal symbols is mapped to different layers of the plurality of layers and different resource elements of the plurality of resource elements in accordance with a repetition pattern; and decoding the plurality of spinal symbols.

Aspect 12: The method of Aspect 11, wherein the repetition pattern includes repetitions that are distributed equally spaced along spines and prioritizing repetitions in a highest spine number within a resource element to cause the repetition to occur across a pair of resource elements.

Aspect 13: The method of any of Aspects 11-12, wherein a spinal symbol transmitted via a last resource element, of the plurality of resource elements, is transmitted with repetitions via the last resource element.

Aspect 14: The method of any of Aspects 11-13, wherein the at least one spinal symbol is mapped to a first transmission vector of the plurality of transmission vectors of the MIMO transmission matrix and a second transmission vector of the plurality of transmission vectors of the MIMO transmission matrix, the first transmission vector being associated with a first resource element of the plurality of resource elements and a first layer of the plurality of layers and the second transmission vector being associated with a second resource element of the plurality of resource elements that is different from the first resource element and a second layer of the plurality of layers that is different from the first layer.

Aspect 15: The method of Aspect 14, wherein the plurality of spinal symbols are mapped to the plurality of transmission vectors in ascending order with respect to the plurality of resource elements and in descending order with respect to the plurality of layers.

Aspect 16: The method of Aspect 15, wherein the first layer is associated with a smaller noise radius relative to the second layer.

Aspect 17: The method of Aspect 15, wherein the first layer is a last layer to which the plurality of spinal symbols are mapped for the first resource element and the second layer is a first layer to which the plurality of spinal symbols are mapped for the second resource element.

Aspect 18: The method of Aspect 14, wherein decoding the plurality of spinal symbols comprises: utilizing a first hypothesis space associated with decoding the at least one spinal symbol mapped to the first layer of the first resource element to reduce a second hypothesis space associated with decoding the at least one spinal symbol mapped to the second layer of the second resource element.

Aspect 19: The method of any of Aspects 11-18, wherein the first transmission vector corresponds to a first matrix element of the plurality of matrix elements and the second transmission vector corresponds to a second matrix element of the plurality of matrix elements, and wherein the first matrix element and the second matrix element are non-adjacent matrix elements within the MIMO transmission matrix.

Aspect 20: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-19.

Aspect 21: An apparatus for wireless communication at a device, the apparatus comprising one or more memories and one or more processors coupled to the one or more memories, the one or more processors configured to cause the device to perform the method of one or more of Aspects 1-19.

Aspect 22: An apparatus for wireless communication, the apparatus comprising at least one means for performing the method of one or more of Aspects 1-19.

Aspect 23: A non-transitory computer-readable medium storing code for wireless communication, the code comprising instructions executable by one or more processors to perform the method of one or more of Aspects 1-19.

Aspect 24: A non-transitory computer-readable medium storing a set of instructions for wireless communication, the set of instructions comprising one or more instructions that, when executed by one or more processors of a device, cause the device to perform the method of one or more of Aspects 1-19.

Aspect 25: A device for wireless communication, the device comprising a processing system that includes one or more processors and one or more memories coupled with the one or more processors, the processing system configured to cause the device to perform the method of one or more of Aspects 1-19.

Aspect 26: An apparatus for wireless communication at a device, the apparatus comprising one or more memories and one or more processors coupled to the one or more memories, the one or more processors individually or collectively configured to cause the device to perform the method of one or more of Aspects 1-19.

Aspect 27: A device comprising a processing system that includes one or more processors and one or more code-storing memories coupled with the one or more processors, the processing system configured to cause the device to perform the method of one or more of Aspects 1-19.

Aspect 28: A device comprising a processing system that includes processor circuitry and code-storing memory circuitry, the processing system configured to cause the device to perform the method of one or more of Aspects 1-19.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A transmitting device, comprising:
a processing system that includes one or more processors and one or more code-storing memories coupled with the one or more processors, the processing system configured to cause the transmitting device to:
obtain a plurality of spinal symbols associated with a multiple input multiple output (MIMO) spinal code encoding scheme;
map each spinal symbol of the plurality of spinal symbols to one or more transmission vectors of a plurality of transmission vectors of a MIMO transmission matrix based at least in part on a layer index within a resource element of a plurality of resource elements,
wherein at least one spinal symbol of the plurality of spinal symbols is mapped to at least a first layer and a second layer of a plurality of layers of the MIMO spinal code encoding scheme and at least to a first resource element and a second resource element of the plurality of resource elements in accordance with a repetition pattern; and
transmit the plurality of spinal symbols in accordance with the MIMO transmission matrix.

2. The transmitting device of claim 1, wherein the repetition pattern includes repetitions that are distributed equally spaced along spines and prioritizing repetitions in a highest spine number within a given resource element to cause the repetition to occur across a pair of resource elements, or
wherein the repetition pattern includes a quantity of the repetitions that is greater than a quantity of resource elements, of the plurality of resource elements, wherein the given resource element includes a first repetition that ends in a lowest spine number within the given resource element and begins in highest spine number in a previous resource element, and wherein the given resource element includes a second repetition in a next two lowest spine numbers in the given resource element.

3. The transmitting device of claim 1, wherein the at least one spinal symbol is mapped to a first transmission vector of the plurality of transmission vectors of the MIMO transmission matrix and a second transmission vector of the plurality of transmission vectors of the MIMO transmission matrix, the first transmission vector being associated with the first resource element and the first layer and the second transmission vector being associated with the second resource element and the second layer, and wherein the second resource element is different from the first resource element and the second layer is different from the first layer.

4. The transmitting device of claim 3, wherein the plurality of spinal symbols are mapped to the plurality of transmission vectors in ascending order with respect to the plurality of resource elements and in descending order with respect to the plurality of layers.

5. The transmitting device of claim 4, wherein the first layer is associated with a first noise radius and the second layer is associated with a second noise radius, wherein the first noise radius is smaller than the second noise radius.

6. The transmitting device of claim 4, wherein the first layer is a last layer to which the plurality of spinal symbols are mapped for the first resource element and the second layer is a first layer to which the plurality of spinal symbols are mapped for the second resource element.

7. The transmitting device of claim 3, wherein each transmission vector of the plurality of transmission vectors corresponds to a matrix element of a plurality of matrix elements of the MIMO transmission matrix, and wherein each matrix element of the plurality of matrix elements is associated with a single resource element of the plurality of resource elements of the MIMO spinal code encoding scheme and a single layer of the plurality of layers of the MIMO spinal code encoding scheme.

8. The transmitting device of claim 7, wherein the first transmission vector corresponds to a first matrix element of the plurality of matrix elements and the second transmission vector corresponds to a second matrix element of the plurality of matrix elements, and wherein the first matrix element and the second matrix element are non-adjacent matrix elements within the MIMO transmission matrix.

9. The transmitting device of claim 1, wherein the repetition pattern is configured to reduce a hypothesis space associated with decoding the at least one spinal symbol during a decoding process.

10. The transmitting device of claim 1, wherein a rate matching scheme associated with mapping each spinal symbol of the plurality of spinal symbols to the one or more transmission vectors indicates a code rate, a set of spines of the MIMO spinal encoding scheme to be used for transmission of the plurality of spinal symbols, and a quantity of symbols associated with each spine of the set of spines.

11. A method of wireless communication performed by a transmitting device, comprising:
obtaining a plurality of spinal symbols associated with a multiple input multiple output (MIMO) spinal code encoding scheme;
mapping each spinal symbol of the plurality of spinal symbols to one or more transmission vectors of a plurality of transmission vectors of a MIMO transmission matrix based at least in part on a layer index within a resource element of a plurality of resource elements,
wherein at least one spinal symbol of the plurality of spinal symbols is mapped to at least a first layer and a second layer of a plurality of layers of the MIMO spinal code encoding scheme and at least to a first resource element and a second resource element of the plurality of resource elements in accordance with a repetition pattern; and
transmitting the plurality of spinal symbols in accordance with the MIMO transmission matrix.

12. The method of claim 11, wherein the repetition pattern includes repetitions that are distributed equally spaced along spines and prioritizing repetitions in a highest spine number within a given resource element to cause the repetition to occur across a pair of resource elements, or
wherein the repetition pattern includes a quantity of the repetitions that is greater than a quantity of resource elements, of the plurality of resource elements, wherein the given resource element includes a first repetition that ends in a lowest spine number within the given resource element and begins in highest spine number in a previous resource element, and wherein the given resource element includes a second repetition in a next two lowest spine numbers in the given resource element.

13. The method of claim 11, wherein the at least one spinal symbol is mapped to a first transmission vector of the plurality of transmission vectors of the MIMO transmission matrix and a second transmission vector of the plurality of transmission vectors of the MIMO transmission matrix, the first transmission vector being associated with the first resource element and the first layer and the second transmission vector being associated with the second resource element and the second layer, and wherein the second resource element is different from the first resource element and the second layer is different from the first layer.

14. The method of claim 13, wherein the plurality of spinal symbols are mapped to the plurality of transmission vectors in ascending order with respect to the plurality of resource elements and in descending order with respect to the plurality of layers.

15. The method of claim 14, wherein the first layer is associated with a first noise radius and the second layer is associated with a second noise radius, wherein the first noise radius is smaller than the second noise radius.

16. The method of claim 14, wherein the first layer is a last layer to which the plurality of spinal symbols are mapped for the first resource element and the second layer is a first layer to which the plurality of spinal symbols are mapped for the second resource element.

17. The method of claim 13, wherein each transmission vector of the plurality of transmission vectors corresponds to a matrix element of a plurality of matrix elements of the MIMO transmission matrix, and wherein each matrix element of the plurality of matrix elements is associated with a single resource element of the plurality of resource elements of the MIMO spinal code encoding scheme and a single layer of the plurality of layers of the MIMO spinal code encoding scheme.

18. The method of claim 17, wherein the first transmission vector corresponds to a first matrix element of the plurality of matrix elements and the second transmission vector corresponds to a second matrix element of the plurality of matrix elements, and wherein the first matrix element and the second matrix element are non-adjacent matrix elements within the MIMO transmission matrix.

19. The method of claim 11, wherein the repetition pattern is configured to reduce a hypothesis space associated with decoding the at least one spinal symbol during a decoding process.

20. A non-transitory computer-readable medium storing a set of instructions for wireless communication, the set of instructions comprising:
one or more instructions that, when executed by one or more processors of a transmitting device, cause the transmitting device to:
obtain a plurality of spinal symbols associated with a multiple input multiple output (MIMO) spinal code encoding scheme;
map each spinal symbol of the plurality of spinal symbols to one or more transmission vectors of a plurality of transmission vectors of a MIMO transmission matrix based at least in part on a layer index within a resource element of a plurality of resource elements,
wherein at least one spinal symbol of the plurality of spinal symbols is mapped to at least a first layer and a second layer of a plurality of layers of the MIMO spinal code encoding scheme and at least to a first resource element and a second resource element of the plurality of resource elements in accordance with a repetition pattern; and
transmit the plurality of spinal symbols in accordance with the MIMO transmission matrix.
